(19) United States
(12) Patent Application Publication
(10) Pub. No.: US 2024/0393420 A1
(43) Pub. Date: Nov. 28, 2024

(54) INFORMATION PROCESSING DEVICE, INFORMATION PROCESSING METHOD, AND PROGRAM

(71) Applicant: Sony Semiconductor Solutions Corporation, Kanagawa (JP)

(72) Inventors: Hiroaki Nakano, Tokyo (JP); Kohei Yamamoto, Kanagawa (JP); Takuya Ichihara, Tokyo (JP); Masaya Takano, Kanagawa (JP)

(21) Appl. No.: 18/696,612

(22) PCT Filed: Oct. 19, 2022
(86) PCT No.: PCT/JP22/38980

§ 371 Date: Mar. 28, 2024

(30) Foreign Application Priority Data
Nov. 10, 2021 (JP) 2021-183286

(51) Int. Cl. G01S 5/02

(52) U.S. Cl. CPC G01S 5/0244

(57) ABSTRACT

Improvements in the accuracy of position measurement based on a result of distance measurement using a phase-based method or distance measurement using a communication device are disclosed. In one example, an information processing device includes determination processing that determines, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

### TECHNICAL FIELD

The present technology relates to an information processing device, an information processing method, and a program, and particularly relates to a processing technology related to distance measurement using a phase-based method.

### BACKGROUND ART

In recent years, indoor positioning technology has attracted attention. There is a problem that signals of a global navigation satellite system (GNSS) such as Global Positioning System (GPS) cannot be received indoors because satellite radio waves cannot reach there, and therefore, various methods have been proposed. Examples of such methods include pedestrian daed reckoning (PDR), which uses a plurality of sensors such as acceleration sensors and gyro sensors to measure a user's movement and the amount of movement; a method of estimating a position through collation with geomagnetic data; and a method of estimating a distance based on a time of flight (ToF) from the emission of light to the reception of the light.

The following patent literature can be given as examples of related conventional technologies.

### CITATION LIST

### Patent Literature

### [PTL 1]

JP 2018-124181 A

### [PTL 2]

JP 2010-223593 A

### SUMMARY

### Technical Problem

However, for example, in the PDR method, distance measurement errors accumulate, but a problem is that there is no means to correct them. With the method that requires collation of data such as geomagnetic data, there are significant operational problems that it is essential to create a map in advance, and when the layout changes or the map changes, it is also necessary to recreate the data to be collated. With the ToF method, there is a problem that it has significant effects of shadowing (deterioration of distance measurement performance due to the human body), making it impossible to measure accurate distance unless it is in a clear line-of-sight environment.

In order to solve these problems, distance measurement methods using wireless signals have been attracting attention for some time. Technologies for distance measurement through wireless communications have already been proposed such as Bluetooth Low Energy (BLE), where Bluetooth is a registered trademark, Wi-Fi (registered trademark), and Long Term Evolution (LTE). These methods do not require prior training and are easy to deploy into applications.

However, further improvement in distance measurement accuracy is desired for the distance measurement methods using wireless signals. A method using received signal strength indicators (RSSIs) is currently being commercialized as a solution. This is a method of making a determination such that for a higher signal, it is in a closer position, and for a lower signal, it is in a farther position. However, this method is known to be sensitive to multipath (reflected waves). In addition, there is a problem that a large error occurs in the received signal strength indicator depending on the angle of the antenna.

A phase-based method is attracting attention as a method to solve the above problems. The phase-based method is a method of calculating a distance based on the phase characteristics with respect to frequencies of a signal propagation path used for communication. Specifically, in the phase-based method, wireless signal communication is performed between at least two communication devices with varying frequency to obtain the phase characteristics with respect to frequencies of the signal propagation path. Then, based on the phase characteristics, the distance between the two communication devices can be obtained.

In addition, the target device can perform distance measurement with at least three communication devices, and from the distance information, obtain the position of the target device based on triangulation, that is, perform position measurement.

It can be said that there is generally a need for improved accuracy in distance measurement and position measurement.

The present technology has been developed in view of such circumstances, and an object thereof is to improve the accuracy of position measurement based on the results of distance measurement using a phase-based method or distance measurement using a communication device.

### Solution to Problem

An information processing device according to the present technology includes a determination processing unit that determines, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

By performing the distance measurement using the phase-based method, the reliability information can be obtained indicating the reliability of the distance measurement or the reliability of position measurement based on the results of distance measurement. With the above configuration, for a communication device with a low reliability, a communication device to be used for position measurement can be reselected, and for distance measurement with a low reliability using the phase-based method, distance measurement can be performed using another method.

### BRIEF DESCRIPTION OF DRAWING

FIG. 1 is a block diagram illustrating a configuration example of a position measurement system including an information processing device as an embodiment of the present technology.

FIG. 2 is a block diagram illustrating an internal configuration example of the information processing device as the embodiment.

FIG. 3 is a block diagram illustrating an internal configuration example of a wireless communication module included in the information processing device according to the embodiment.

FIG. 4 is a block diagram illustrating an internal configuration example of a communication device in the embodiment.

FIG. 5 illustrates an aspect example of phase measurement in a phase-based method.

FIG. 6 is an explanatory diagram for a phase of a signal propagation path measured in the phase-based method.

FIG. 7 illustrates explanatory diagrams of phase characteristics with respect to frequencies of the signal propagation path.

FIG. 8 illustrates explanatory diagrams of examples of a position measurement method.

FIG. 9 illustrates results of converting frequency characteristics for a phase into time-domain waveform data by inverse Fourier transformation.

FIG. 10 is a diagram illustrating an example of a spatial arrangement of a position measurement system.

FIG. 11 is a functional block diagram illustrating functions included in an information processing device as a first embodiment.

FIG. 12 illustrates explanatory diagrams of an example of a combination of communication devices that can surround the information processing device.

FIG. 13 is a diagram illustrating an example of results of distance measurement and reliabilities of distance measurement for primarily selected communication devices.

FIG. 14 is an explanatory diagram of position measurement reliability.

FIG. 15 is a flowchart illustrating an example of a specific processing procedure to be executed to implement a position measurement method according to the first embodiment.

FIG. 16 is a flowchart illustrating processing as a modification example of the first embodiment.

FIG. 17 is a flowchart of a first example of processing related to determination to reselect a communication device and determination of the number of devices to be reselected.

FIG. 18 is a flowchart of a second example of processing related to determination to reselect a communication device and determination of the number of devices to be reselected.

FIG. 19 is a flowchart of a third example of processing related to determination to reselect a communication device and determination of the number of devices to be reselected.

FIG. 20 is a functional block diagram illustrating functions included in an information processing device as a second embodiment.

FIG. 21 is a flowchart illustrating processing as the second embodiment.

FIG. 22 is a functional block diagram illustrating functions included in an information processing device as a third embodiment.

FIG. 23 illustrates explanatory diagrams of a flow of distance measurement in the third embodiment.

FIG. 24 is a flowchart illustrating an example of a specific processing procedure to implement a distance measurement method as the third embodiment.

### DESCRIPTION OF EMBODIMENT

Hereinafter, embodiments related to the present technology will be described in the following order with reference to the accompanying drawings.

### 1. First Embodiment

(1-1. Configuration Example of Position Measurement System)
(1-2. Internal Configuration Example of Information Processing Device)
(1-3. Internal Configuration Example of Communication Device)
(1-4. Distance Measurement And Position Measurement Using Phase-Based Method)
(1-5. Position Measurement Method As First Embodiment)
(1-6. Processing Procedure)
<2. Second Embodiment>
<3. Third Embodiment>
<4. Modification Example>
<5. Summary of Embodiments>
<6. Present Technology>

### 1. First Embodiment

### (1-1. Configuration Example of Position Measurement System)

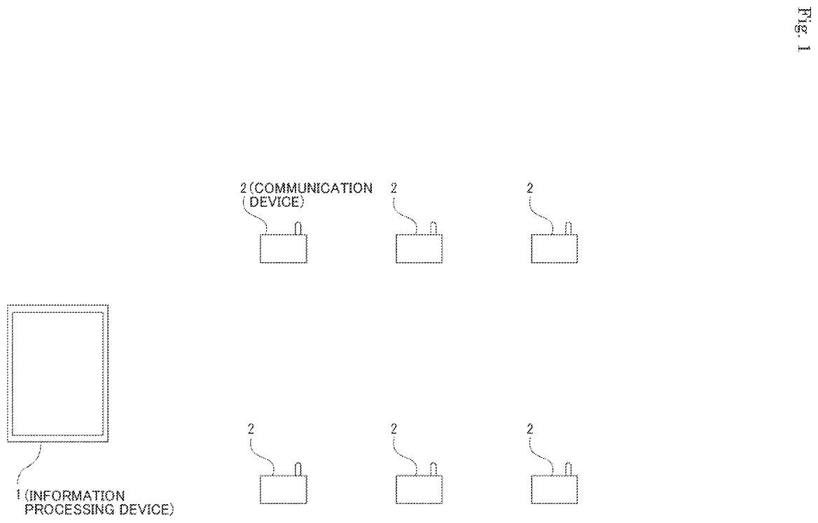

FIG. 1 is a block diagram illustrating a configuration example of a position measurement system including an information processing device 1 as an embodiment of the present technology.

As illustrated, the position measurement system includes the information processing device 1 and a plurality of communication devices 2 that are capable of wireless communication with the information processing device 1.

The information processing device 1 is configured as a computer device that includes a microcomputer including a central processing unit (CPU), a read only memory (ROM), and a random access memory (RAM). In this example, the information processing device 1 is a smartphone, but the information processing device 1 may be another computer device such as a tablet terminal or a personal computer (e.g., a laptop type).

In the present embodiment, it is possible to perform wireless communication as short-range wireless communication between the information processing device 1 and the communication devices 2. Specifically, in this example, it is possible to perform wireless communication using Bluetooth Low Energy (BLE) method, where Bluetooth is a registered trademark.

In this case, each communication device 2 is a device that functions as a BLE beacon.

In the first embodiment, the information processing device 1 performs wireless communication using BLE with the plurality of communication devices 2, and performs distance measurement using a phase-based method with the plurality of communication devices 2. Then, the information processing device 1 uses the results of their distance measurement to perform position measurement of its own position.

A specific method of distance measurement using the phase-based method and position measurement using the results of distance measurement will be described later.

### (1-2. Internal Configuration Example of Information Processing Device)

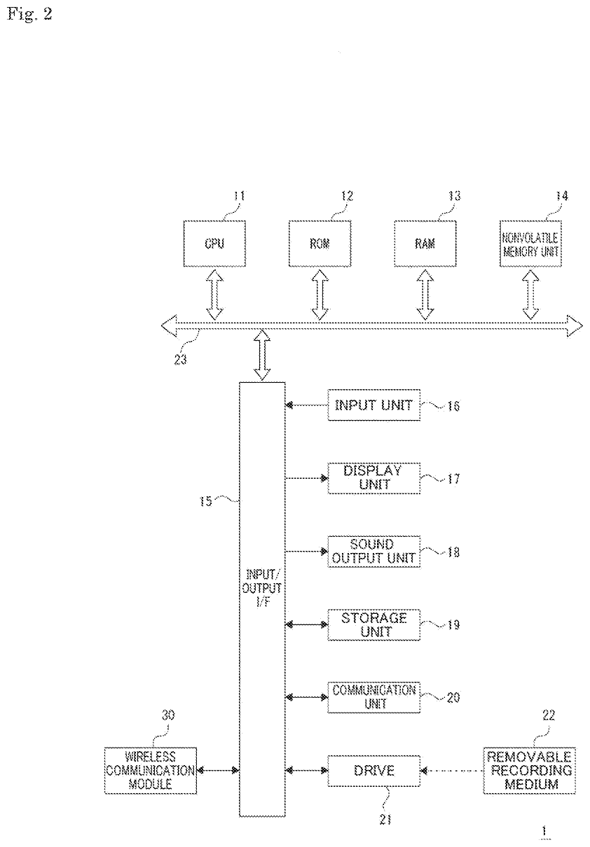

FIG. 2 is a block diagram illustrating a hardware configuration example of the information processing device 1.

As illustrated, the information processing device 1 includes a CPU 11. The CPU 11 executes various types of processing according to a program stored in a ROM 12 or a nonvolatile memory unit 14 such as an electrically erasable programmable read-only memory (EEP-ROM), or a program loaded into a RAM 13 from a storage unit 19. The RAM 13 also appropriately stores data and the like necessary for the CPU 11 to execute various types of processing.

The program as used herein may include an application program for implementing position measurement based on the results of distance measurement using the phase-based method, and an application program for implementing various types of functions using the results of position measurement, such as a navigation function.

The CPU 11, the ROM 12, the RAM 13, and the nonvolatile memory unit 14 are connected to each other via a bus 23. An input/output interface (I/F) 15 is also connected to this bus 23.

An input unit 16 including operators or an operation device is connected to the input/output interface 15. Examples of the input unit 16 as conceivable include various types of operators and operation devices, such as a keyboard, a mouse, keys, a dial, a touch panel, a touch pad, and a remote controller.

An operation is detected by the input unit 16, and a signal corresponding to the detected operation is interpreted by the CPU 11.

A display unit 17 including a liquid crystal display (LCD), an organic electro-luminescence (EL) panel, or the like, and a sound output unit 18 including a speaker or the like, are connected as one body or separate bodies to the input/output interface 15.

The display unit 17 is used to display various types of information, and includes, for example, a display device provided in the housing of the information processing device 1, a separate display device connected to the information processing device 1, or the like.

The display unit 17 displays images for various types of image processing and moving images to be processed, on the display screen in response to an instruction from the CPU 11. The display unit 17 also provides display as a graphical user interface (GUI), for example, various operation menus, icons, and messages in response to an instruction from the CPU 11.

The storage unit 19 including a hard disk drive (HDD), a solid state memory, or the like and a communication unit 20 including a modem or the like may be connected to the input/output interface 15.

The communication unit 20 performs communication with an external device via a network line such as the Internet.

A drive 21 is also connected to the input/output interface 15 as necessary, and a removable recording medium 22 such as a magnetic disk, an optical disc, a magneto-optical disc, or a semiconductor memory is mounted therein as appropriate.

The drive 21 can be used to read out data files such as programs used for each instance of processing from the removable recording medium 22. The read data files are stored in the storage unit 19 or images or sounds included in the data files are output to the display unit 17 or the sound output unit 18. A computer program or the like read out from the removable recording medium 22 is installed into the storage unit 19 as necessary.

A wireless communication module 30 is also connected to the input/output interface 15.

The wireless communication module 30 is a communication module for performing short-range wireless communication with an external device.

Specifically, the wireless communication module 30 in this example is configured to be able to perform wireless communication with the communication devices 2 using BLE.

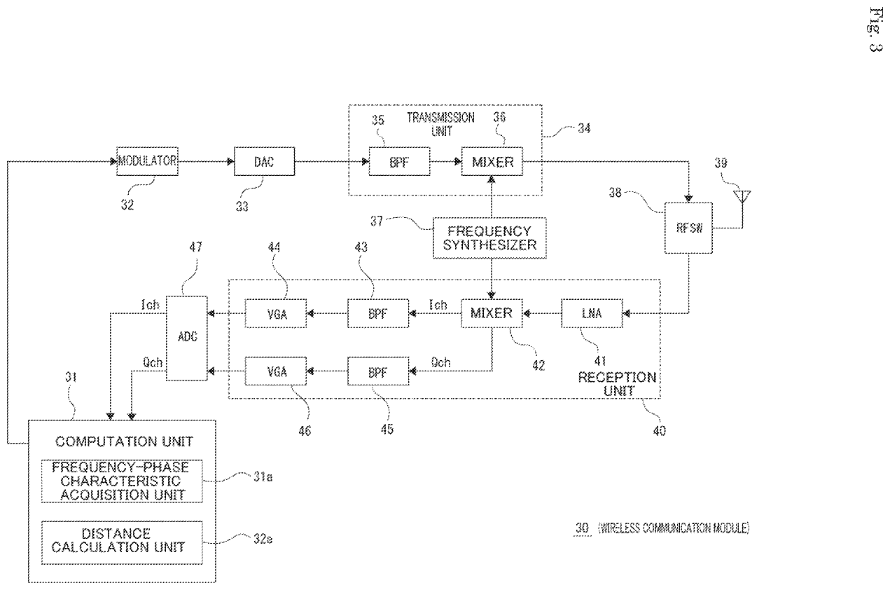

FIG. 3 is a block diagram illustrating an internal configuration example of the wireless communication module 30.

As illustrated, the wireless communication module 30 includes a computation unit 31, a modulator 32, a digital-to-analog converter (DAC) 33, a transmission unit 34, a frequency synthesizer 37, an RF switch (SW) 38, an antenna 39, a reception unit 40, and an analog-to-digital converter (ADC) 47.

As described above, the wireless communication module 30 in this example is capable of performing wireless communication using BLE, and with BLE, the time required for operations that require large amounts of power, such as connection establishment and data communication, is reduced as much as possible. Therefore, power consumption can be suppressed and the wireless communication module 30 can be downsized.

The modulator 32 performs signal modulation processing for performing wireless communication with the communication devices 2. Here, for example, IQ modulation is performed as the modulation processing. In IQ modulation, in-phase (I) (in-phase component) channel and quadrature (Q) channel (quadrature component) signals are used as baseband signals.

The modulator 32 performs modulation processing as IQ modulation on data to be transmitted supplied from the computation unit 31.

The DAC 33 converts a digital signal from the modulator 32 into an analog signal. The analog signal converted by this DAC 33 is supplied to the transmission unit 34.

The transmission unit 34 is a block that transmits signals through wireless communication. As illustrated, the transmission unit 34 includes a band pass filter (BPF) 35 and a mixer 36. The BPF 35 passes only signals in a specific frequency band. In other words, the BPF 35 supplies to the mixer 36 only signals in a specific frequency band from among the analog signals from the DAC 33.

The mixer 36 mixes a local oscillation frequency signal supplied from the frequency synthesizer 37 with the signal supplied from the BPF 35, thereby converting the signal into a transmission frequency signal for wireless communication.

The frequency synthesizer 37 supplies a frequency signal used for transmission and reception. Specifically, the frequency synthesizer 37 includes a local oscillator inside, and is used for converting a radio frequency signal and a baseband signal for wireless communication.

The RF switch 38 is a switch that switches radio frequency (RF) signals. This RF switch 38 connects the transmission unit 34 to the antenna 39 for transmission, and connects the reception unit 40 to the antenna 39 for reception.

The antenna 39 is an antenna for transmitting and receiving signals through wireless communication.

The reception unit 40 is a block that receives signals through wireless communication. As illustrated, the reception unit 40 includes a low noise amplifier (LNA) 41, a mixer 42, a BPF 43, a variable gain amplifier (VGA) 44, a BPF 45, and a VGA 46.

The LNA 41 amplifies the RF signal received by the antenna 39. The mixer 42 mixes the local oscillation frequency signal supplied from the frequency synthesizer 37 with the signals supplied from the LNA 41 to obtain I-channel and Q-channel signals. The I-channel signal (denoted as “Ich” in the diagram) is supplied to the BPF 43, and the Q-channel signal (denoted as “Qch” in the diagram) is supplied to the BPF 45.

The I-channel signal obtained by the mixer 42 is input to the BPF 43, from which only signals in a specific frequency band are extracted and supplied to the VGA 44. On the other hand, the Q-channel signal obtained by the mixer 42 is input to the BPF 45, from which only signals in a specific frequency band are extracted and supplied to the VGA 46.

The VGA 44 and the VGA 46 function as analog variable gain amplifiers that adjust the gains of the I-channel signal supplied from the BPF 43 and the Q-channel signal supplied from the BPF 45, respectively.

The ADC 47 converts the I-channel and Q-channel signals from the reception unit 40, that is, the I-channel and Q-channel signals output via the VGA 44 and VGA 46, from analog signals to digital signals.

The I-channel and Q-channel signals converted into the digital signals are supplied to the computation unit 31.

The computation unit 31 is configured to include, for example, a microcomputer that includes a central processing unit (CPU), a read only memory (ROM), and a random access memory (RAM). The CPU executes various types of processing in accordance with programs stored in the ROM or programs loaded from the ROM into the RAM.

For example, the computation unit 31 performs processing of supplying data to be transmitted to the modulator 32 and modulating the data. The computation unit 31 also performs processing of demodulating the received data based on the data of the I-channel and Q-channel signals supplied from the ADC 47.

In particular, the computation unit 31 has, as functions to perform distance measurement through wireless communication, functions of a frequency-phase characteristic acquisition unit 31a and a distance calculation unit 31b illustrated in the diagram.

The frequency-phase characteristic acquisition unit 31a acquires the phase characteristics with respect to frequencies of a signal propagation path to each communication device 2. In this example, in order to perform distance measurement using the phase-based method as distance measurement through wireless communication, processing is performed to obtain the phase characteristics of a signal propagation path with respect to frequencies.

The distance calculation unit 31b calculates a distance to the communication device 2 based on the phase characteristics with respect to frequencies of the signal propagation path, acquired by the frequency-phase characteristic acquisition unit 31a.

### (1-3. Internal Configuration Example of Communication Device)

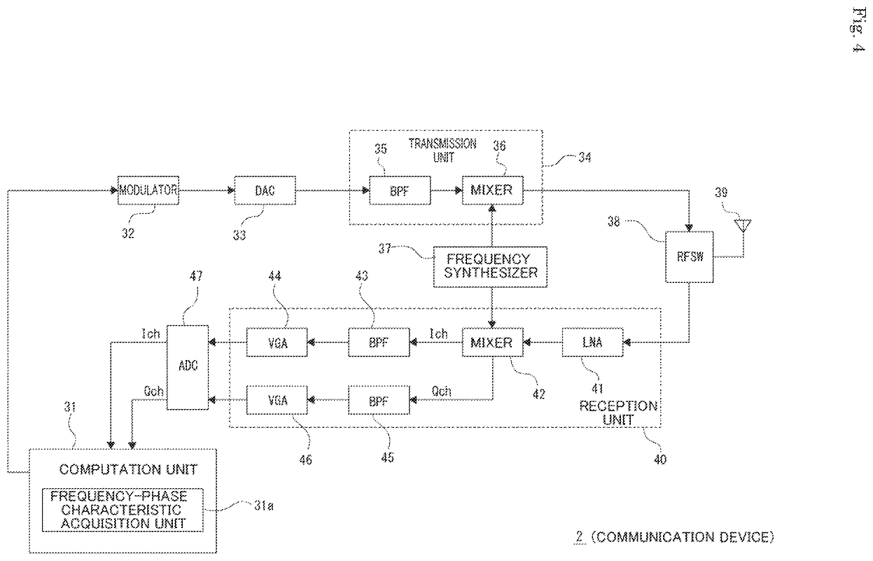

FIG. 4 is a block diagram illustrating an internal configuration example of the communication device 2.

As can be seen from a comparison with FIG. 3, the internal configuration of the communication device 2 is similar to the internal configuration of the wireless communication module 30, and thus, redundant explanation will be avoided.

In the communication device 2, although the distance calculation unit 31b is not illustrated because it is not essential, the communication device 2 may have a configuration in which the distance calculation unit 31b is included.

### (1-4. Distance Measurement and Position Measurement Using Phase-Based Method)

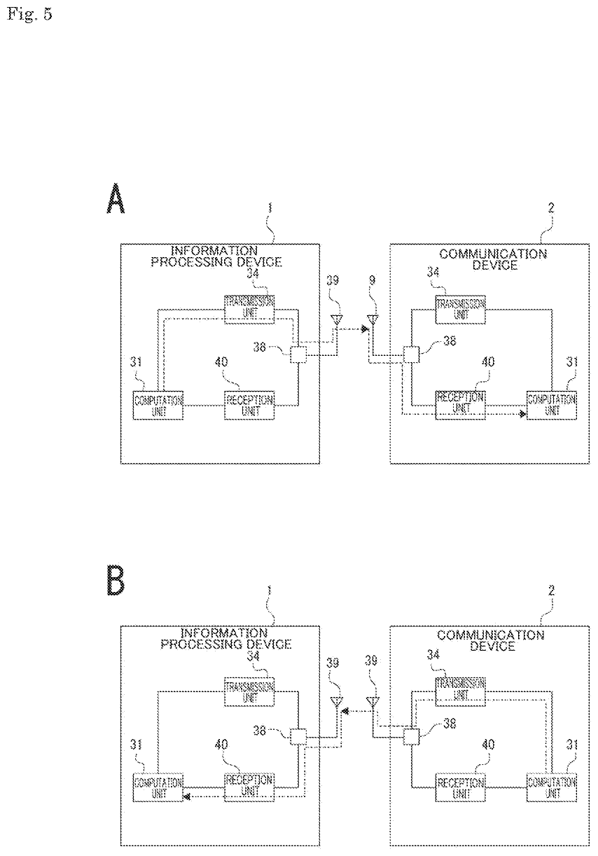

FIG. 5 is a diagram illustrating an aspect example of phase measurement in the phase-based method. In the phase-based method, a phase is measured based on the result of wireless communication performed with varying frequency between two devices having a wireless communication function, that is, in this example, between the information processing device 1 (the wireless communication module 30) and any of the communication devices 2.

In this measurement, first, as illustrated in A of FIG. 5, a measurement signal is transmitted from the information processing device 1 (initiator) to the communication device 2 (reflector).

As used herein, the initiator refers to a device that performs processing of calculating a distance based on a measured phase, and the reflector refers to a device paired with the initiator that exchanges measurement signals with the initiator.

FIG. 5 mainly illustrates flows of measurement signals related to phase measurement, and representations of, for example, the modulator 32, the DAC 33, the frequency synthesizer 37, and the ADC 47 are omitted.

In A of FIG. 5, in the information processing device 1 serving as an initiator, a measurement signal is transmitted from the antenna 39 through the transmission unit 34 from the computation unit 31. In the communication device 2 serving as a reflector, the measurement signal is received by the reception unit 40 via the antenna 39.

Then, as illustrated in B of FIG. 5, the measurement signal is transmitted back from the communication device 2 to the information processing device 1.

Specifically, in the communication device 2, a measurement signal is transmitted from the antenna 39 through the transmission unit 34 from the computation unit 31, and in the information processing device 1, the measurement signal is received by the reception unit 40 via the antenna 39, and the phase characteristics between the two devices are measured by the computation unit 31. By performing such round-trip communication, it is possible to appropriately measure the phase characteristics between the two devices.

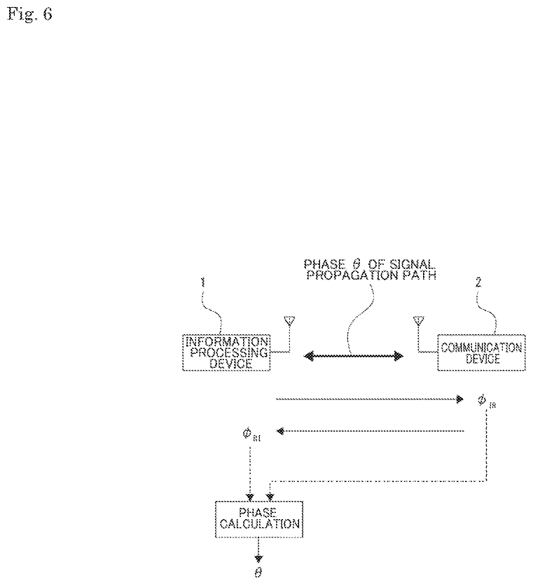

FIG. 6 is an explanatory diagram for a phase θ of a signal propagation path measured in the phase-based method.

When a measurement signal is transmitted from the information processing device 1 side to the communication device 2 side as illustrated in A of FIG. 5, the communication device 2 measures a signal phase φ of the measurement signal. Here, the signal phase φ measured when the measurement signal is transmitted from the information processing device 1 (initiator) side to the communication device 2 (reflector) side in this way is expressed as “φ_{IR}” herein.

When a measurement signal is transmitted from the communication device 2 side to the information processing device 1 side as illustrated in B of FIG. 5, the information processing device 1 measures a signal phase φ of the measurement signal. The signal phase φ measured when the measurement signal is transmitted from the communication device 2 side to the information processing device 1 side in this way is expressed as “φ_{RI}”.

Here, the signal phase φ is obtained by the following [Equation 1] when the I-channel and Q-channel signals obtained by receiving the measurement signal are represented by “I” and “Q”, respectively.

$$φ = {tan}^{- 1} \times Q / I \qquad [ Equation 1 ]$$

In the phase-based method, the phase θ of the signal propagation path is obtained based on the signal phase φ_{IR} and the signal phase φ_{RI} described above. Specifically, the phase θ is obtained by averaging the signal phase φ_{IR} and the signal phase φ_{RI}. As this averaging calculation, the average value of the signal phase φ_{IR} and the signal phase φ_{RI} may be calculated, and the sum of the signal phase φ_{IR} and the signal phase φ_{RI} may be calculated.

In the phase-based method, the measurement of the phase θ as described above is performed for each frequency with sequentially varying frequency of the measurement signal within a predetermined frequency band. In other words, the measurement of the phase θ is performed for each of a plurality of frequencies. The “predetermined frequency band” as used herein may be a frequency band determined as a usage band according to communication standards, such as the 2.4 GHz band (band from 2400 MHz to 2480 MHz) in the case of BLE, for example.

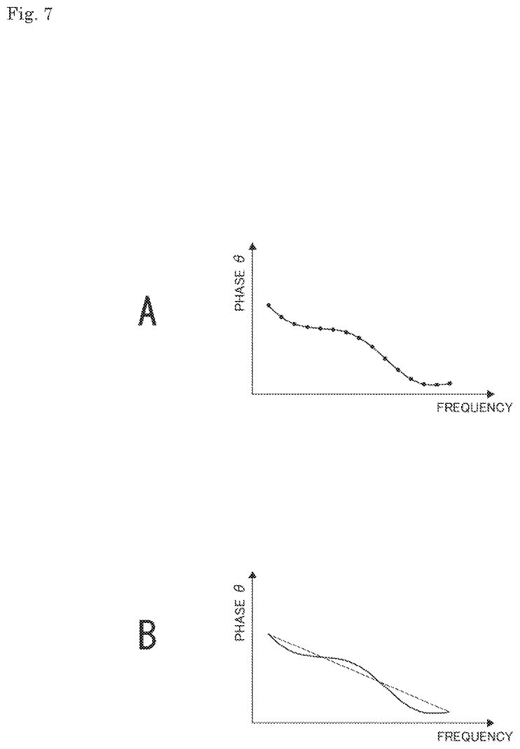

When the measurement of the phase θ is performed for each frequency within a predetermined frequency band as described above, results of measurement are obtained as illustrated in A of FIG. 7. The black circles in the figure represent the results of measurement of the phase θ at the respective frequencies.

In other words, the results illustrated in A of FIG. 7 can be expressed as the phase characteristics with respect to frequencies of the signal propagation path.

In the phase-based method, distance measurement is performed based on how the phase θ varies when the frequency varies. Specifically, in the characteristics of the phase θ with varying frequency, the magnitude of the slope of the phase θ as illustrated in B of FIG. 7 correlates with the magnitude of the distance. This means that the steeper the slope of the phase θ, the greater the distance. Therefore, the distance can be calculated based on the slope of the phase θ.

An example of a specific method of calculating a distance is a method of obtaining a group delay τ from the slope of the phase θ and multiplying the group delay t by the speed of light (=299792458 m/s). The reason why the group delay u is used is to eliminate the influence of 2n indeterminacy of the phase. The group delay t is the phase θ differentiated by an angular frequency ω.

The method of calculating a distance based on the characteristics of phase θ with respect to frequencies, that is, the phase characteristics with respect to frequencies of the signal propagation path, is not limited to the above-described method, and various methods can be used. For example, a method may be used in which not only the characteristics of the phase θ with respect to the frequencies but also the characteristics of the amplitude with respect to frequencies are obtained, in other words, not only the frequency characteristics of the phase θ but also the frequency characteristics of the amplitude are obtained, these frequency characteristics of the phase θ and the amplitude are converted into time response waveforms by an inverse Fourier transform such as inverse fast Fourier transform (IFFT), and a distance is calculated based on the time response waveforms.

Since the phase θ varies depending on the frequency, distance measurement using the phase-based method can be implemented theoretically by measuring the phase θ for at least two or more frequencies.

As described in FIG. 6, the phase-based method is a method of calculating a distance by obtaining the phase θ from the results of measuring the signal phase φ in both directions from the information processing device 1 to the communication device 2 and from the communication device 2 to the information processing device 1. In other words, this can be said to be a method of obtaining a distance based on relative difference information of the signal phase φ. Therefore, the phase-based method has an advantage that it is possible to prevent the distance measurement accuracy from being reduced due to the absolute value of the circuit delay of each block related to signal transmission and reception and varying values depending on temperature characteristics.

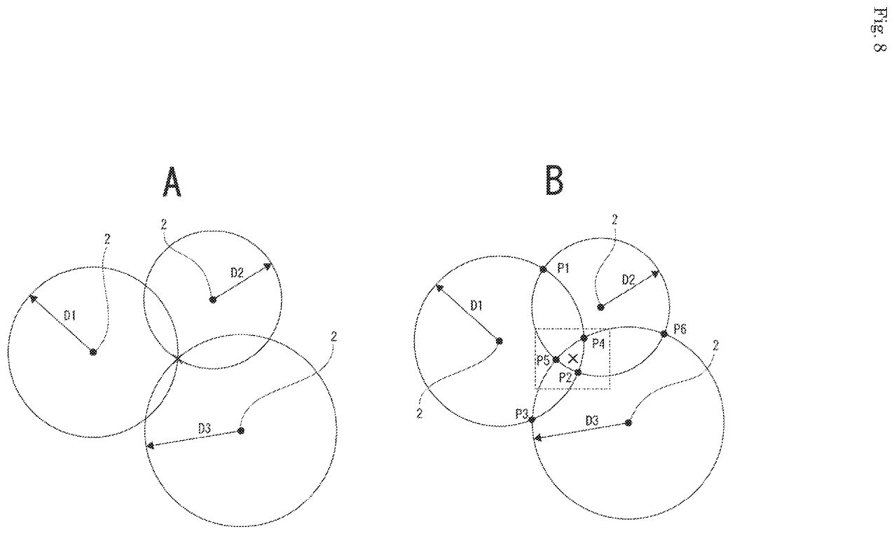

Next, position measurement will be described with reference to FIG. 8. For example, if the information processing device 1 performs distance measurement with each of at least three communication devices 2 and can determine distances D to the three communication devices 2, the position of the information processing device 1 can be determined by triangulation. Specifically, since the position at which each communication device 2 serving as a beacon is located is known, the position of the information processing device 1 can be obtained as an intersection point (x mark in the diagram) of three circles each having a radius corresponding to a distance D (D1 to D3 in the diagram) to each communication device 2, with a center being the position of each communication device 2, as illustrated in A of FIG. 8.

However, in reality, it is rare for the three circles to intersect at one point. In other words, even when the circles intersect, there are typically a plurality of intersection points P. In FIG. 8, B illustrates a case where three circles do not intersect at one point, and six intersection points P1, P2, P3, P4, P5, and P6 in total are generated by these three circles. In this case, the position of the device to be subjected to position measurement (i.e., the information processing device 1) can be calculated based on the region defined by these intersection points P. Specifically, a method can be used in which among any three points that can be selected from the six intersection points P, three points that have the smallest area of the triangle defined by connecting the points, in other words, three intersection points that define a portion where the three circles overlap (three points: intersection points P2, P4, and P5 in the example illustrated), are determined, and the position of the centroid of a triangle defined by the three points is obtained as the position of the device to be subjected to position measurement.

The method of calculating the position of the device to be subjected to position measurement by using the distances D to the plurality of communication devices 2 is not limited to the method of calculating a position by using the above-described centroid method, and various methods can be used without being limited to a specific method.

### (1-3. Position Measurement Method as First Embodiment)

In the present embodiment in which distance measurement for position measurement is performed using the phase-based method, the phase-based method has the following advantage in addition to the advantage in terms of distance measurement accuracy. That is, a reasonable reliability can be calculated because time-domain data is obtained.

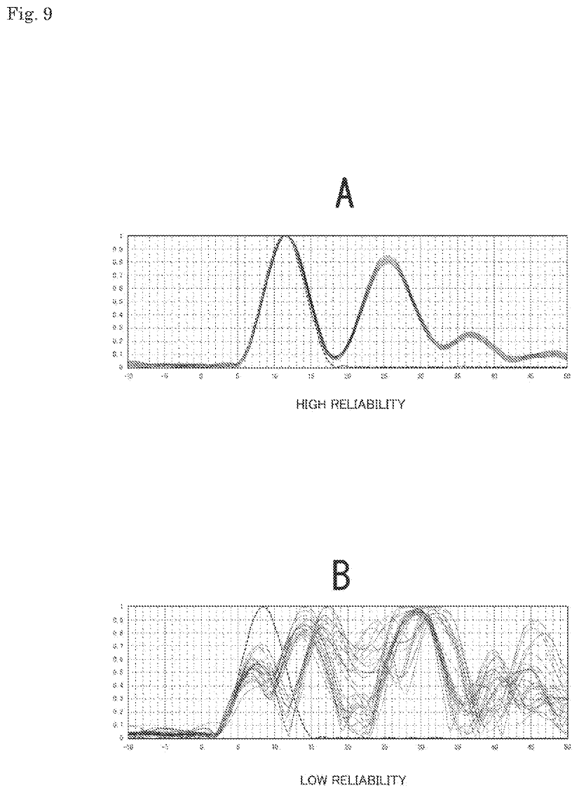

FIG. 9 illustrates results of converting frequency characteristics for the phase θ into time-domain waveform data by inverse Fourier transform (e.g., IFFT).

In FIG. 9, A illustrates results for a high reliability, and B illustrates results for a low reliability. In each case, the time-domain waveform data obtained by performing inverse Fourier transform on the frequency characteristics of the phase θ as measured multiple times are superimposed. In A and B of FIG. 9, the horizontal axis is time, the vertical axis is amplitude, and the thick dotted line indicates an ideal one-wave model (ideal model).

For the high reliability in A of FIG. 9, the first peak (preceding wave component) is clear and it can be confirmed that it matches the ideal model. In the results of measurements performed multiple times, there is little variation in the peak of the preceding wave component.

On the other hand, for the low reliability in B of FIG. 9, the peak as the preceding wave component is less clear than that in A of FIG. 9, and the variations in the results of measurements performed multiple times are also large.

The ability to obtain such information on time-domain waveform data is a unique advantage of the phase-based method, which acquires the frequency characteristics of the phase θ by frequency sweep, and is also an advantage that cannot be obtained by using conventional distance measurement methods using, for example, received signal strength indicators (RSSIs).

Here, various methods of calculating a reliability based on the frequency characteristics of the phase θ as described above are conceivable. Basically, it can be calculated by finding a correlation with time-domain waveform data as an ideal model as illustrated in FIG. 9. As an example, a method may be used that calculates the degree of correlation between the above-described preceding wave components with reference to the time-domain waveform data obtained by inverse Fourier transform of the frequency characteristics of the phase θ that were actually measured and the time-domain waveform data as an ideal model. For example, a method may be used that calculates the degree of correlation using a window function for the preceding wave component.

Here, the reliability calculated as the degree of correlation with the time-domain waveform data as an ideal model as described above is the reliability regarding distance measurement when distance measurement is performed using the phase-based method. From this point on, this reliability will be referred to as “distance measurement reliability” below.

The distance measurement reliability is generally also referred to as “signal quality” or “multipath influence degree”.

By the reliability being calculated, it is possible to perform distance measurement using only the communication device 2 with a high reliability in performing position measurement, thereby making it possible to improve the accuracy of position measurement.

However, it should be noted here that the distance measurement reliability as described above can only be obtained by performing the operation for distance measurement using the phase-based method, specifically, by measuring the phase θ at each frequency.

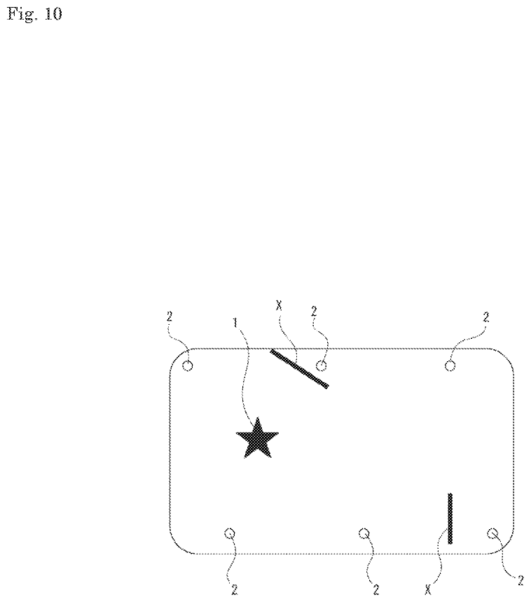

FIG. 10 schematically illustrates a state where the position measurement system illustrated in FIG. 1 is arranged in a certain space, such as inside a building. When performing position measurement, the position measurement system first uses at least three communication devices 2, and at this time, from the viewpoint of position measurement accuracy, a communication device 2 with a low distance measurement accuracy should not be selected. As illustrated in the figure, among the communication devices 2 in the position measurement system, there is a communication device 2 that is blocked by an obstacle X when viewed from the information processing device 1 as the device to be subjected to position measurement. The accuracy of distance measurement for position measurement in such a communication device 2 may be reduced.

In this case, it is conceivable that the information processing device 1 performs communication processing to obtain the frequency characteristics of the phase θ with all communication devices 2 with which it can communicate, and calculates a distance measurement reliability for each communication device 2 to determine the communication device 2 to be used for position measurement. However, it is not desirable to perform communication processing involving frequency sweep with all communication devices 2 because it increases the time required for position measurement. In addition, in position measurement when the information processing device 1 is moving, there is a risk that the position measurement accuracy may be reduced due to a difference in distance measurement timing between the plurality of communication devices 2 to be used for position measurement.

From these points of view, it is required to efficiently select communication devices 2 to be used for position measurement.

Therefore, in the present embodiment, a position measurement method is proposed as described below.

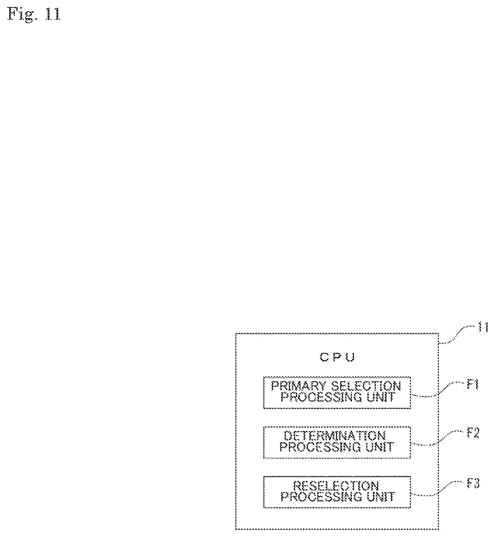

FIG. 11 is a functional block diagram illustrating functions related to the position measurement method as the first embodiment, which are included in the CPU 11 of the information processing device 1.

As illustrated, the CPU 11 has functions as a primary selection processing unit F1, a determination processing unit F2, and a reselection processing unit F3.

The primary selection processing unit F1 primarily selects a plurality of communication devices 2 to be used for position measurement.

This selection processing by the primary selection processing unit F1 can be defined as processing of selecting the communication devices 2 before performing communication processing for distance measurement using the phase-based method (communication for measuring the phase θ at each frequency) with the communication devices 2 in order to output one result of position measurement. In the present embodiment as described later, after the communication devices 2 are selected, communication devices 2 may be selected again based on the reliability (reselection processing performed by the reselection processing unit F3, which will be described later) in the primary selection in order to output one result of position measurement. In this respect, the expression “primary” selection is used.

The terms are now defined.

The above-described “communication processing for distance measurement using the phase-based method” means communication processing to obtain the characteristics of the phase θ with respect to frequencies, that is, the phase characteristics with respect to frequencies of a signal propagation path. Specifically, this means processing of communicating a plurality of measurement signals with different frequencies with the communication devices 2.

The primary selection performed by the primary selection processing unit F1 may be performed as follows.
1) Performed based on RSSIs (received signal strength indicators from each communication device 2).
2) Performed based on position coordinate information indicating the position at which the communication device 2 is arranged.
3) Performed based on RSSIs and position coordinate information indicating the position at which the communication device 2 is arranged.
4) Performed based on the position coordinate information of the information processing device 1 (device to be subjected to position measurement) calculated based on RSSIs and the position coordinate information indicating the position at which the communication device 2 is arranged.

Here, the RSSIs and the position coordinate information indicating the position at which the communication device 2 is arranged can be obtained from a BLE advertising signal.

It is assumed that an advertising signal from the communication device 2 is received by the information processing device 1 at a step before position measurement is started. The information processing device 1 can communicate with the communication device 2 from which the advertising signal has been received.

RSSI information can be obtained when the advertising signal is received. Position coordinate information of the communication device 2 included in the advertising signal can also be obtained.

It is now assumed that a prescribed number of communication devices 2 (prescribed number for position measurement) are used for position measurement. The prescribed number (prescribed number for position measurement) as used herein means a value that defines the number of communication devices 2 to be used in the position measurement processing to obtain the results of position measurement to be output.

In this example, it is assumed that the plurality of communication devices 2 for position measurement are arranged two-dimensionally, and therefore, the prescribed number is “3”, which is the number of communication devices 2 required to implement position measurement by the triangulation described above.

In a case where position measurement is performed by communication devices 2 arrange three-dimensionally, the required number of communication devices 2 to implement position measurement is “4”, and the prescribed number will be set as “4”, accordingly.

For the primary selection processing unit F1, examples of the selection based on RSSIs in 1) above include a method of selecting a prescribed number of top communication devices 2 with higher RSSIs.

Further, examples of the selection based on the position coordinate information of the communication devices 2 given in 2) above include a method of selecting such that the area of the figure (triangle in this example) defined by connecting the position coordinates of the communication devices 2 is a certain value or more.

Furthermore, examples of the selection based on RSSIs and the position coordinate information of the communication devices 2 given in 3) above include a method of selecting the communication device 2 with the maximum RSSI and the remaining number of top communication devices 2 that are short in distance from that position (i.e., the prescribed number−1).

In addition, examples of the selection based on the position coordinate information of the information processing device 1 calculated based on RSSIs and the position coordinate information of the communication devices 2 given in 4) above include a method of selecting the communication device 2 closest to the position of the information processing device 1 calculated based on RSSIs and the remaining number of top communication devices 2 that are short in distance from the closest communication device 2.

Furthermore, examples of the selection method of 4) include a method of selecting a combination of communication devices 2 that can surround the position of the information processing device 1 calculated based on RSSIs.

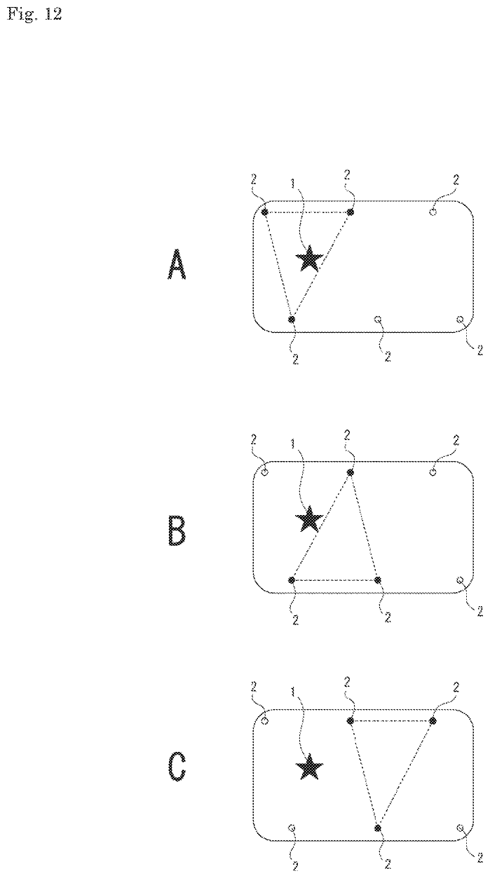

FIG. 12 illustrates diagrams of examples of a combination of communication devices 2 that can surround the information processing device 1 and a combination of communication devices 2 that cannot surround the information processing device 1, in the latter method of 4).

In FIG. 12, A illustrates the case of surrounding, and B and C illustrate the case of not surrounding.

In the case of adopting the latter method of 4), a prescribed number of communication devices 2 are sequentially selected in their different combinations, for example, as illustrated in A to C of FIG. 12, and when a combination of communication devices 2 that can surround the information processing device 1 is found, that combination is primarily selected.

For the latter method of 4), instead of simply selecting a combination of communication devices 2 that can surround the information processing device 1, a method of selecting a combination of communication devices 2 with the minimum dilution of precision (DOP) may be used.

In FIG. 11, the determination processing unit F2 determines, based on the reliability information obtained for the communication devices 2 primarily selected by the primary selection processing unit F1, whether or not reselection of communication devices 2 to be used for position measurement is required. In making this determination, first, the wireless communication module 30 executes communication processing for distance measurement using the phase-based method with each of the primarily selected communication devices 2 to calculate a reliability. Specifically, as the reliability, the distance measurement reliability described above is calculated for each communication device 2. Then, based on the calculated distance measurement reliabilities, it is determined whether or not reselection of communication devices 2 to be used for position measurement is required. Specifically, for example, it is determined whether or not the condition that the distance measurement reliabilities for all communication devices 2 are equal to or higher than a predetermined value is satisfied. If the condition is not satisfied, a result of determination indicating that reselection is required is obtained, and if the condition is satisfied, a result of determination indicating that reselection is not required is obtained.

In this example, not only communication processing for distance measurement using the phase-based method but also distance measurement is executed with each of the primarily selected communication devices 2. Even the distance measurement being executed in this way makes it possible to make a determination based on the reliability of position measurement (position measurement reliability), which will be described later, as a determination as to whether reselection is required.

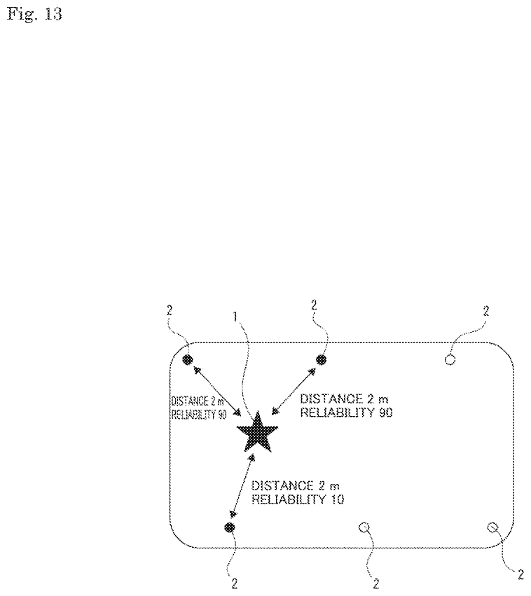

FIG. 13 illustrates examples of distances to the primarily selected communication devices 2 obtained by performing distance measurement using the phase-based method with the communication devices 2, and distance measurement reliabilities calculated for the communication devices 2.

It is here assumed that as each distance measurement reliability, a parameter is used that is determined in, for example, 100 levels based on an impulse response waveform. The parameter approaches 100 as the reliability of the result of distance measurement increases. For example, for the time-domain waveform with a high reliability illustrated in A of FIG. 9, the reliability is expressed as 80, and for the time-domain waveform with a low reliability illustrated in B of FIG. 9, the reliability is expressed as 20.

For the reliability, not only the distance measurement reliability but also the position measurement reliability indicating a reliability of position measurement can be used.

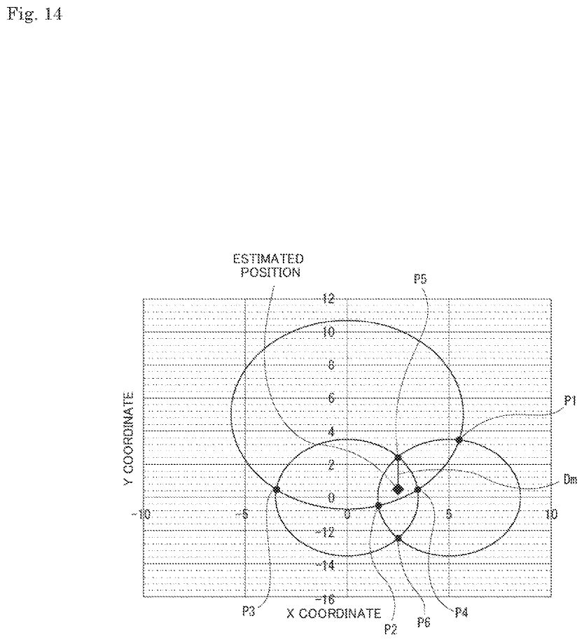

The position measurement reliability will be described with reference to FIG. 14. As described above, once the distances D1, D2, and D3 to the three communication devices 2, respectively, are obtained, position measurement can be performed based on the intersection points of circles with radii that are the distances D1, D2, and D3, respectively. In this case, ideally, the circles intersect at one point as illustrated in A of FIG. 9, that is, a portion where the three circles overlap is one point, while in many cases, the three circles do not intersect at one point, and a portion where the three circles overlap has a certain area as illustrated in FIG. 14. Therefore, the size of the area of the portion where the three circles overlap can be used as an indication for position measurement reliability.

FIG. 14 illustrates, as the position measurement reliability to be obtained, a distance indicated as “Dm” in the figure, that is, the longest distance (a distance from the estimated position to an intersection point P5 in the figure) of distances from the position of the information processing device 1 (the estimated position in the figure) obtained from the results of distance measurement to intersection points P that define a portion where three circles overlap (intersection points P2, P4, and P5 in the figure), of six intersection points P (intersection points P1 to P6).

In the example of FIG. 14, the coordinates of the estimated position are (2.5, 0.48) and the coordinates of the intersection point P5 are (2.5, 2.45), and therefore, the position measurement reliability is calculated as 1.97.

Of course, its value can also be normalized with, for example, 100 levels. For example, by setting 0 m (meter) as position measurement reliability=100, setting 10 m or more as position measurement reliability=0, and setting a distance between them as 100−10× the distance Dm, position measurement reliability 1.97 is replaced with 80.3.

The method of calculating a position measurement reliability is not limited to the method exemplified above.

For example, the area of the portion where the three circles overlap can be used as the position measurement reliability. Alternatively, the average value of distances from the estimated position to the intersection points P that define the portion where the three circles overlap, of the six intersection points P may be used as the position measurement reliability.

In a case where position measurement calculations are performed using simultaneous equations based on the coordinates of the intersection points P, the sum of squared errors in the calculations may be used as the position measurement reliability.

In the case of using the position measurement reliability, the determination made by the determination processing unit F2 may be, for example, a determination as to whether or not the condition that the position measurement reliability is equal to or lower than a predetermined threshold THp is satisfied. In this case, if the condition is satisfied, a result of determination is obtained indicating that reselection is required, and if the condition is not satisfied, a result of determination is obtained indicating that reselection is not required.

In FIG. 11, the reselection processing unit F3 reselects communication devices 2 to be used for position measurement when the determination processing unit F2 determines that reselection is required.

For convenience of explanation, the processing of the reselection processing unit F3 will be described when distance measurement reliability information is used as reliability information in the determination made by the determination processing unit F2. Processing when position measurement reliability is used as reliability information will be described later.

In this example, the reselection processing unit F3 performs reselection based on distance measurement reliability information obtained for each of the primarily selected communication devices 2.

Specifically, in this example, based on the distance measurement reliability used in the determination made by the determination processing unit F2, the communication device(s) 2 having a distance measurement reliability equal to or higher than a predetermined value are maintained in a selected state, and from among the remaining communication device(s) 2 (i.e., the remaining communication device(s) 2 among all communication devices 2 that can communicate) as device(s) to be reselected, communication device(s) 2 are reselected.

This makes it possible to improve the efficiency of processing related to reselection.

It is here assumed that the reselection is such that the number of communication devices 2 that will be in the selected state after reselection is the prescribed number. Specifically, if there is only one communication device 2 with a distance measurement reliability equal to or higher than the predetermined value, two communication devices 2 are reselected, and if two communication devices 2 with a distance measurement reliability equal to or higher than the predetermined value, one communication device 2 is reselected.

In the following description, that number of communication devices 2 to be reselected, which is obtained based on the distance measurement reliabilities of the primarily selected communication devices 2 is referred to as the “target number of devices T”.

The reselection of communication device(s) 2 may be performed by the reselection processing unit F3 as follows.
5) Perform reselection based on the RSSI
6) Perform reselection based on position coordinate information indicating the position(s) at which the communication device(s) 2 are arranged.
7) Perform reselection based on: the position coordinate information of the information processing device 1 (corresponding to the coordinate information of the estimated position described above) obtained by position measurement based on the results of distance measurement using the phase-based method performed for each of the primarily selected communication devices 2; and the position coordinate information indicating the position(s) at which the communication device(s) 2 are arranged.

Examples of 5) above include a method of reselecting the top T communication devices 2 with highest RSSIs among the remaining communication devices 2.

Examples of 6) above include a method of reselecting the communication device 2 with the highest RSSI and the top T−1 communication devices 2 with the shortest distances to the highest communication device 2, where the target number of devices T is 2 or more.

Alternatively, examples of 6) above include a method of reselecting the communication device 2 with a distance measurement reliability equal to or higher than the predetermined value and the newly selected communication devices 2 such that the area of a figure defined by connecting these communication devices 2 is equal to or greater than a predetermined value. Furthermore, examples of 6) above include a method of reselecting the top T communication devices 2 with the shortest distances to the communication device 2 with the highest distance measurement reliability.

Examples of 7) above include a method of reselecting the top T communication devices 2 with the shortest distances from the estimated position of the information processing device 1 (the position of the information processing device 1 determined by position measurement based on the results of distance measurement using the phase-based method performed for each of the primarily selected communication devices 2).

Alternatively, examples of 7) above include a method of reselecting communication devices 2 that can surround the estimated position of the information processing device 1 together with communication devices 2 with distance measurement reliabilities equal to or higher than the predetermined value.

The latter method of 7) above may be performed in the same manner as described above with reference to FIG. 12. In other words, T communication devices 2 are sequentially selected to be combined with the communication device(s) 2 with distance measurement reliabilities equal to or higher than the predetermined value, and when T communication devices 2 that can surround the estimated position are found, the T communication devices 2 are reselected.

As the latter method of 7) above, a method of selecting communication devices 2 with the minimum DOP may be used instead of reselecting communication devices 2 that can simply surround the estimated position.

In this example, when the CPU 11 reselects communication devices 2, the CPU 11 causes the wireless communication module 30 to execute communication processing for distance measurement using the phase-based method for the reselected communication devices 2 to calculate distance measurement reliabilities. If the distance measurement reliabilities of all reselected communication devices 2 are equal to or higher than the predetermined value, the CPU 11 performs processing for position measurement calculations to output results of position measurement based on the results of distance measurement with the primarily selected communication devices 2 and the results of distance measurement with the reselected communication devices 2.

On the other hand, if there is a communication device 2 with a distance measurement reliability not equal to or higher than the predetermined value among the reselected communication devices 2, the CPU 11 reselects communication devices 2 again. After that, reselection is repeated until the distance measurement reliabilities of all reselected communication devices 2 become the predetermined value or higher.

### (1-6. Processing Procedure)

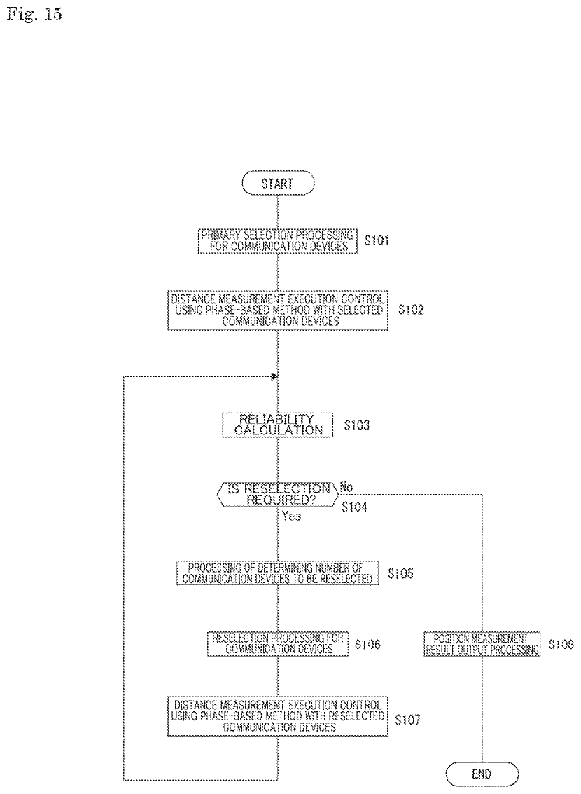

With reference to a flowchart of FIG. 15, an example of a specific processing procedure to be executed to implement the position measurement method according to the first embodiment described above will be described.

In this example, the processing illustrated in FIG. 15 is executed by the CPU 11 illustrated in FIG. 2 based on a program stored in, for example, the ROM 12 or the storage unit 19.

First, the CPU 11 performs primary selection processing for communication devices 2 in step S101. Specifically, the primary selection processing for communication devices 2 is performed using the method exemplified above.

In step S102 following step S101, the CPU 11 performs distance measurement execution control using the phase-based method with the selected communication devices 2. Specifically, the wireless communication module 30 is controlled so that distance measurement using the phase-based method is performed with each of the communication devices 2 primarily selected in step S101.

In this example, the wireless communication module 30 executes even the distance measurement for the primarily selected communication devices 2 in order to enable calculations of position measurement reliabilities. However, in the case of using the distance measurement reliabilities as reliability information, it is not necessary to perform even the distance measurement, and it is sufficient to perform at least even the communication processing for distance measurement using the phase-based method.

In step S103 following step S102, the CPU 11 performs reliability calculation processing. Specifically, distance measurement reliabilities are calculated based on the information on the frequency characteristics of the phase θ obtained by the distance measurement execution control in step S102. In a case of using position measurement reliabilities as reliability information, as will be described later, position measurement reliabilities are calculated.

The methods of calculating a distance measurement reliability and calculating a position measurement reliability have already been described, and thus, redundant explanation will be avoided.

In step S104 following step S103, the CPU 11 determines whether or not reselection is required. For example, as described above, a determination of whether or not the distance measurement reliabilities of all communication devices 2 are equal to or higher than the predetermined value, based on the distance measurement reliability calculated for each of the primarily selected communication devices 2 is made as a determination of whether or not reselection is required.

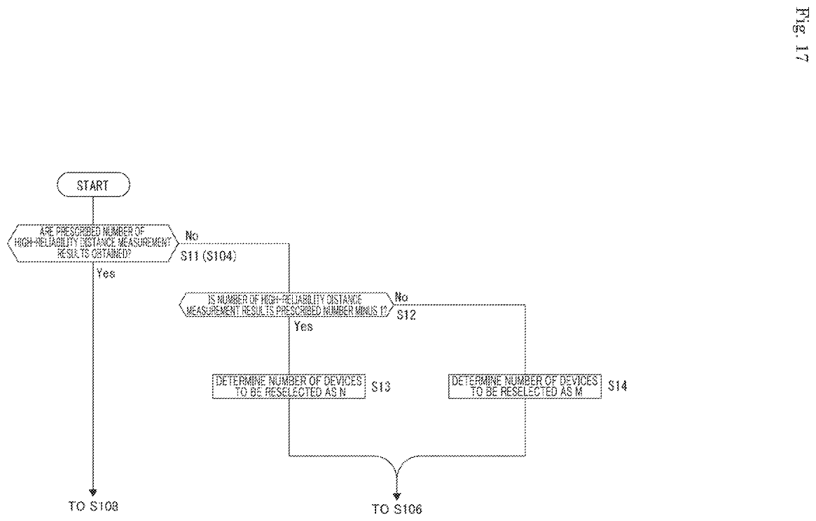

Another example may be adopted for the reselection determination in step S104, and that example will be described in detail with reference to FIGS. 17 to 19.

If a result of determination is obtained indicating that reselection is required in step S104, the CPU 11 proceeds to step S105 to execute processing of determining the number of communication devices to be reselected. It is here defined that the number of communication devices to be reselected is the aforementioned target number of devices T, and the number of communication devices 2 that will be in a selected state after reselection is a prescribed number.

Another example may be adopted for the processing of determining the number of communication devices in step S105, and that example will be described in detail with reference to FIGS. 17 to 19.

In step S106 following step S105, the CPU 11 performs reselection processing for communication devices 2. This method of reselection processing has already been described, and thus, redundant explanation will be avoided.

In response to the reselection processing having been executed in step S106, the CPU 11 performs distance measurement execution control using the phase-based method with the reselected communication devices 2 in step S107. Then, in response to the distance measurement execution control having been performed in step S107, the CPU 11 returns to step S103. As a result, reliability information as distance measurement reliabilities or position measurement reliabilities can be calculated for the reselected communication devices 2. After that, in step S104, a determination is made as to whether or not further reselection is required based on the reliability information of the reselected communication devices 2, and if further reselection is required, the processing returns to step S105 and subsequent steps. In other words, this means that reselection is repeated until a result of determination is obtained indicating that reselection is not required (in other words, in this example, until the distance measurement reliabilities of all reselected communication devices 2 become the predetermined value or higher).

If a result of determination is obtained indicating that reselection is not required in step S104, the CPU 11 proceeds to step S108 to perform position measurement result output processing. Specifically, processing of outputting the results of position measurement to, for example, an application that uses the position information of the information processing device 1 is performed.

In a case of using only the distance measurement reliabilities are used as the reliability information in the position measurement result output processing in step S108, since position measurement is not performed for the prescribed number of selected communication devices 2, position measurement calculations are performed to output the results of position measurement.

In this case, if the wireless communication module 30 has not executed even the distance measurement with the selected communication devices 2 to calculate distance measurement reliabilities, distance measurement calculations are executed based on the information on the frequency characteristics of the phase θ obtained through communication processing with the selected communication devices 2, and position measurement calculations are performed based on the results of distance measurement to output the results of position measurement.

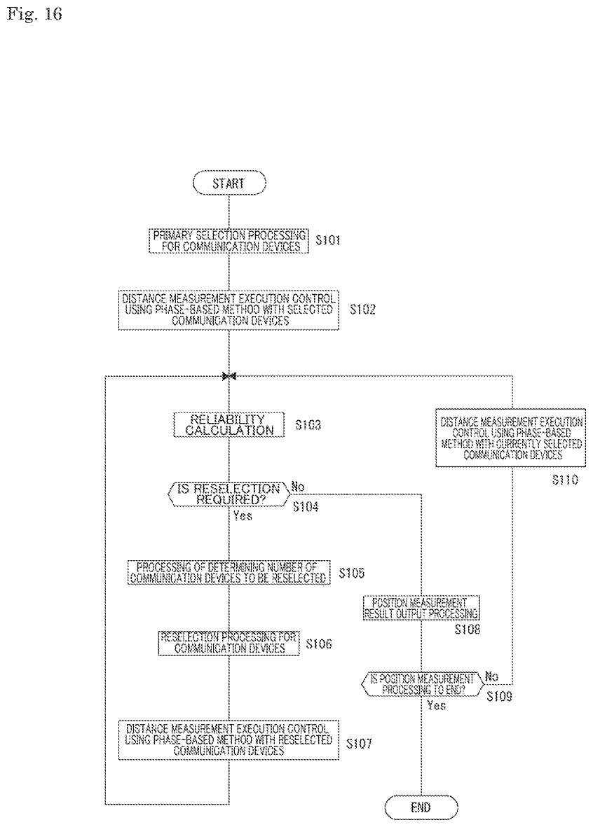

FIG. 16 is a flowchart illustrating processing as a modification example of the first embodiment.

The processing as this modification example is processing based on the premise of sequentially acquiring the position of the information processing device 1 when the information processing device 1 moves, such as when applied to navigation purposes.

In the following description, processing that are the same as the processing already described will be given the same step numbers, and thus, the description thereof will be omitted.

In this case, in response to the position measurement result output processing being executed in step S108, the CPU 11 determines in step S109 whether or not the position measurement processing is to end. In other words, it is determined whether or not a predetermined condition defined as a condition for ending the position measurement processing is satisfied.

If it is determined that the position measurement processing is not to end, the CPU 11 proceeds to step S110, performs distance measurement execution control using the phase-based method with the currently selected communication devices 2, and returns to step S103.

As a result, in a case where results of position measurement are to be output sequentially, for the output of the first results of position measurement, the primary selection processing described in FIG. 15, the processing of determining whether reselection is required, and the reselection processing when reselection is required are performed, and for the output of the subsequent results of position measurement, it is determined whether or not reselection is required for the currently selected communication devices 2 based on their reliability information, and if it is determined that reselection is required, the reselection processing is performed.

Therefore, it is possible to improve the position measurement accuracy when results of position measurement are sequentially output.

Other examples of the processing of determining whether or not reselection is required (step S104) and the processing of determining the number of communication devices to be reselected (step S105) will be described with reference to flowcharts of FIGS. 17 to 19.

FIG. 17 is a flowchart of processing as a first example.

In this case, the CPU 11 determines in step S11 whether or not a prescribed number of high-reliability distance measurement results have been obtained. The high-reliability distance measurement results as used herein mean, in other words, communication devices 2 with distance measurement reliabilities equal to or higher than the predetermined value.

The determination processing in step S11 corresponds to determining whether or not the condition that the distance measurement reliabilities of all primarily selected communication devices 2 are equal to or higher than the predetermined value is satisfied.

In step S11, if a prescribed number of high-reliability distance measurement results have been obtained, the processing of the CPU 11 proceeds to step S108 (position measurement result output processing).

On the other hand, if a prescribed number of high-reliability distance measurement results have not been obtained, the CPU 11 proceeds to step S12 to determine whether or not the number of high-reliability distance measurement results is the predetermined number minus 1. In other words, it is a determination as to whether or not the number of communication devices 2 with distance measurement reliabilities equal to or higher than the predetermined value is equal to the prescribed number minus 1.

If the number of high-reliability distance measurement results is the prescribed number minus 1, the CPU 11 proceeds to step S13 to determine the number of devices to be reselected as N. and proceeds to step S106 (reselection processing). On the other hand, if the number of high-reliability distance measurement results is not the prescribed number minus 1 (i.e., if the number of communication devices 2 with distance measurement reliabilities not equal to or higher than the predetermined value is two or more), the CPU 11 proceeds to step S14 to determine the number of devices to be reselected as M (where M>N), and the processing proceeds to step S106.

Here, for N and M referred to above, they may be set as N=1 and M=2, for example. In this case, if N=1, reselection is performed so that the number of communication devices 2 that will be in the selected state after reselection matches the prescribed number.

If M=2, reselection is performed so that the number of communication devices 2 that will be in the selected state after reselection is greater than the prescribed number.

If reselection is performed so that the number of communication devices 2 that will be in the selected state after reselection is equal to the prescribed number, for a reselected communication device 2 with a low reliability, it is necessary to select another communication device 2 immediately. On the other hand, if reselection is performed so that the number of communication devices that will be in the selected state after reselection is greater than the prescribed number for position measurement, even when one of the reselected communication devices 2 has a low reliability, there is a possibility that another reselected communication device 2 has a high reliability. Thus, even when one of the reselected communication devices 2 has a low reliability, it is possible to eliminate the need to immediately select another communication device 2.

Therefore, it is possible to shorten the time required for position measurement and reduce the processing load related to position measurement.

According to the processing illustrated in FIG. 17 described above, the number of devices to be reselected is set to be variable depending on the number of high-reliability distance measurement results among the primarily selected communication devices 2 (the number of communication devices 2 with distance measurement reliabilities equal to or higher than the predetermined value). Specifically, in the above example, the fewer the number of communication devices 2 with distance measurement reliabilities equal to or higher than the predetermined value, the more the number of devices to be reselected is increased.

When the number of communication devices 2 with distance measurement reliabilities equal to or higher than the predetermined value is small among the primarily selected communication devices 2, it is estimated that the environment is such that it is difficult to perform distance measurement. Therefore, increasing the number of devices to be reselected makes it possible to reduce the possibility that selection is required again, and thus to shorten the time required for position measurement and reduce the processing load related to position measurement.

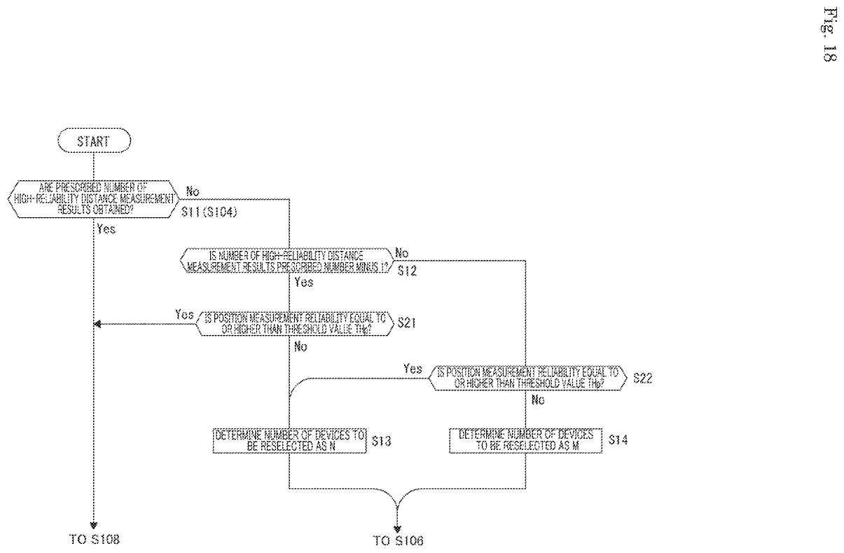

FIG. 18 is a flowchart of processing as a second example.

In this case, if the CPU 11 determines in step S11 that the prescribed number of high-reliability distance measurement results has not been obtained, in step S12 determines whether or not the number of high-reliability distance measurement results is the prescribed number minus 1, and as a result, determines that the number of high-reliability distance measurement results is the prescribed number minus 1, the CPU 11 proceeds to step S21 to determine whether or not each position measurement reliability is equal to or higher than a threshold value THp.

If the position measurement reliability is equal to or higher than the threshold value THp, the processing of the CPU 11 proceeds to step S108. Specifically, if there is only one communication device 2 with a distance measurement reliability not equal to or higher than the predetermined value among the primarily selected communication devices 2, it is determined that reselection is not required as long as the position measurement reliability is equal to or higher than the threshold value THp, and the distance measurement result output processing of step S108 is executed.

On the other hand, if it is determined in step S21 that the position measurement reliability is not equal to or higher than the threshold value THp, the CPU 11 proceeds to step S13 to determine the number of devices to be reselected as N, and proceeds to step S106. Specifically, even if there is only one communication device 2 with a distance measurement reliability not equal to or higher than the predetermined value among the primarily selected communication devices 2, it is determined that reselection is required unless the position measurement reliability is equal to or higher than the threshold value THp, and then, the number of devices to be reselected is determined as N.

Further, if it is determined in step S12 that the number of high-reliability distance measurement results is not the prescribed number minus 1, the CPU 11 proceeds to step S22 to determine whether or not the position measurement reliability is equal to or higher than the threshold value THp. If the position measurement reliability is equal to or higher than the threshold value THp, the processing of the CPU 11 proceeds to step S13. Specifically, in a case where the number of communication devices 2 with distance measurement reliabilities not equal to or higher than the predetermined value among the primarily selected communication devices 2 is two or more, if the position measurement reliability is equal to or greater than the threshold value THp, the number of devices to be reselected is determined as N instead of M.

On the other hand, if it is determined in step S22 that the position measurement reliability is not equal to or higher than the threshold value THp, the processing of the CPU 11 proceeds to step S14. Specifically, in a case where the number of communication devices 2 with distance measurement reliabilities not equal to or higher than the predetermined value among the primarily selected communication devices 2 is two or more, the number of devices to be reselected is determined as M as in the case of FIG. 17 unless the position measurement reliability is equal to or higher than the threshold value THp.

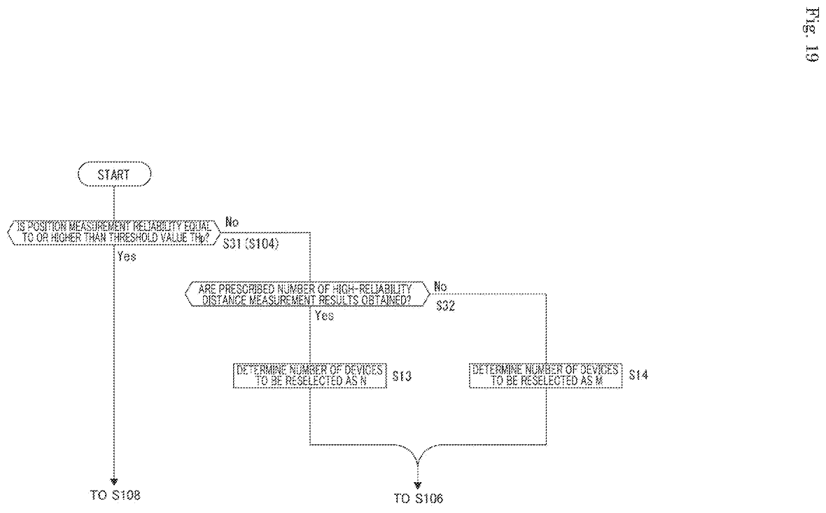

FIG. 19 is a flowchart of processing as a third example.

In this case, the CPU 11 determines in step S31 whether or not the position measurement reliability is equal to or higher than the threshold value THp, and if the position measurement reliability is equal to or higher than the threshold value THp, the processing proceeds to step S108. In other words, in this case, a determination is made as to whether or not reselection is required based on the position measurement reliability rather than the distance measurement reliability.

If it is determined in step S31 that the position measurement reliability is not equal to or higher than the threshold value THp, the CPU 11 proceeds to step S32 to determine whether or not a prescribed number of high-reliability distance measurement results have been obtained.

If a prescribed number of high-reliability distance measurement results have been obtained, the CPU 11 proceeds to step S13 to determine the number of devices to be reselected as N.

On the other hand, if a prescribed number of high-reliability distance measurement results have not been obtained, the CPU 11 proceeds to step S14 to determine the number of devices to be reselected as M.

It has been mentioned above that a determination as to whether or not reselection is required is made based on the distance measurement reliability and the position measurement reliability. Specifically, as described in the processing flow of steps S11→S12→S21 in FIG. 18, even in a case where the condition that the distance measurement reliabilities of all primarily selected communication devices 2 are equal to or higher than the threshold value is not satisfied, if the position measurement reliabilities of those communication devices 2 are equal to or higher than the threshold value THp, a result of determination is obtained indicating that reselection is not required. However, the method of determining whether or not reselection is required based on the distance measurement reliability and the position measurement reliability is not limited to this example. For example, another method may be used in which for the primarily selected communication devices 2, a determination based on the distance measurement reliability and a determination based on the position measurement reliability are made, and when it is determined that the conditions for both determinations are satisfied, a result of determination indicating that reselection is not required is obtained, and otherwise, a result of determination indicating that reselection is required is obtained.

Furthermore, it has been mentioned above that the number of devices to be reselected is determined according to the number of high-reliability distance measurement results among the primarily selected communication devices 2. However, the number of devices to be reselected may be determined based on the position measurement reliabilities calculated for the primarily selected communication devices 2.

### 2. Second Embodiment

A second embodiment will be described below.

In the second embodiment, the position measurement method is switched based on reliability information.

In the second embodiment, the configuration of a position measurement system and the configurations of an information processing device 1 and a communication device 2 are the same as those in the first embodiment, and thus, the description thereof using illustrations will be omitted.

However, in the second embodiment, the information processing device 1 is configured as a device having a wireless communication function using a method other than BLE. Specifically, it has a wireless communication function using the ultra wide band (UWB) method.

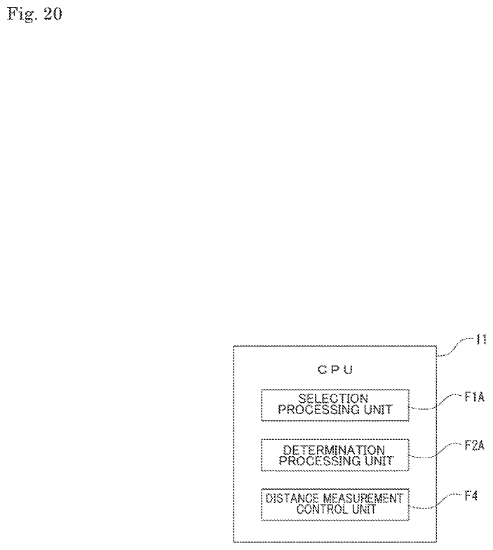

FIG. 20 is a functional block diagram illustrating functions included in a CPU 11 in the information processing device 1 as the second embodiment.

As illustrated, the CPU 11 in this case has the functions as a selection processing unit F1A, a determination processing unit F2A, and a distance measurement control unit F4.

The selection processing unit F1A performs the same processing as the primary selection processing unit F1 described in the first embodiment. Here, the reason why the name is “selection processing unit” is that the second embodiment does not assume that reselection will be performed after the selection of communication devices 2 as the primary selection, and accordingly, the word “selection” is used instead of “primary selection.”

The determination processing unit F2A determines whether or not to perform distance measurement using a method other than the phase-based method, based on reliability information on distance measurement.

In this example, the determination processing unit F2A determines whether or not to perform distance measurement using a method other than the phase-based method, based on the distance measurement reliability calculated for each of the prescribed number of communication devices 2 selected by the selection processing unit F1A. Specifically, it is determined whether or not the condition that the distance measurement reliabilities of all prescribed number of communication devices 2 selected by the selection processing unit F1A are equal to or higher than a predetermined value is satisfied.

The distance measurement control unit F4 controls distance measurement using a method other than the phase-based method based on a result of determination made by the determination processing unit F2A.

Specifically, the determination processing unit F2A in this example controls the distance measurement through wireless communication that uses a wider frequency band than BLE, as distance measurement using another method. More specifically, control is performed so that distance measurement using the UWB method is performed as distance measurement using the other method.

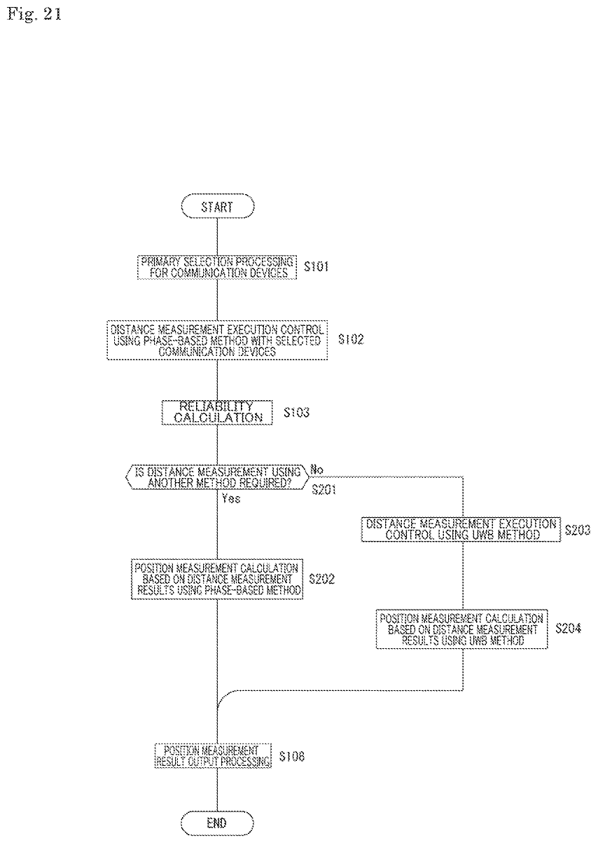

FIG. 21 is a flowchart illustrating processing as the second embodiment. As illustrated, the CPU 11 in this case determines in step S201 whether or not distance measurement using another method is required in response to the distance measurement reliability being calculated for each of the primarily selected communication devices 2 through the reliability calculation processing in step S103. Specifically, a determination as to whether or not the condition that the distance measurement reliabilities of all selected prescribed number of communication devices 2 are equal to or higher than the predetermined value is satisfied is made as a determination as to whether or not distance measurement using another method is required. Specifically, in the processing of step S202, if the above condition is satisfied, a result of determination is obtained indicating that distance measurement using another method is not required, and if the above condition is not satisfied, a result of determination is obtained indicating that distance measurement using another method is required.

If it is determined in step S201 that distance measurement using another method is not required, the CPU 11 proceeds to step S202 to perform position measurement calculations based on the results of distance measurement using the phase-based method. In other words, position measurement calculations are performed based on the distance information obtained by distance measurement performed with the communication devices 2 in step S103.

Then, in response to the position measurement calculations being performed in step S202, the CPU 11 executes position measurement result output processing in step S108, and ends the series of processing illustrated in FIG. 21.

On the other hand, if it is determined in step S201 that distance measurement using another method is not required, the CPU 11 proceeds to step S203 to perform distance measurement execution control using the UWB method. Specifically, the wireless communication module using the UWB method is caused to execute a distance measurement operation using the UWB method. Then, in step S204 following step S203, the CPU 11 performs position measurement calculations based on the results of distance measurement using the UWB method, and executes the position measurement result output processing of step S108.

In a case where distance measurement using the phase-based method has a low reliability, by the processing in the second embodiment as described above, the distance measurement to perform position measurement can be switched to distance measurement through wireless communication with a wider frequency band, that is, distance measurement using a method that is expected to further improve distance measurement accuracy.

Therefore, it is possible to improve position measurement accuracy.

### 3. Third Embodiment

A third embodiment relates to a tag search function.

The tag search function as used herein is a function of presenting to the user at least a distance to a wireless communication device serving as a tag, for example, in an information processing device 1 such as a smartphone. This tag search function allows the user to search objects to which tags have been attached in advance.

Currently, in the tag search function, distance information is acquired by switching between distance measurement based on RSSIs (received signal strength indicators) using BLE and distance measurement using the UWB method. Specifically, first, by performing distance measurement based on an RSSI, it is roughly determined whether a tag is likely to be present in a somewhat close position, such as in the same room or building. If the tag is likely to be present nearby, the distance measurement is switched to distance measurement using the UWB method to obtain distance information to the tag in order to determine a more specific distance.

Using such a currently known method makes it possible to reduce the chances of performing distance measurement using the UWB method, which is disadvantageous in terms of power consumption, and achieve both high-precision distance measurement and low power consumption. However, in reality, due to the low accuracy of distance measurement based on RSSIs, a tag is incorrectly determined to be present nearby even though it is not, and accordingly, distance measurement using the UWB method is executed unnecessarily, failing to reduce the power consumption as intended.

In view of this point, the third embodiment is to solve the above problem by performing distance measurement using the phase-based method in place of a currently known distance measurement based on RSSIs in the tag search function.

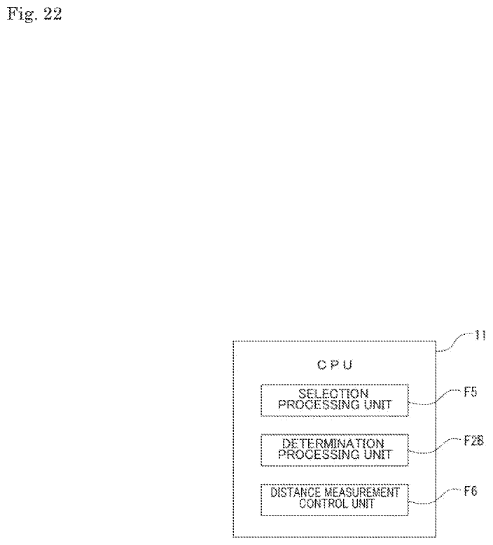

FIG. 22 is a functional block diagram illustrating functions included in a CPU 11 in the information processing device 1 as the third embodiment.

In the third embodiment, the hardware configuration of the information processing device 1 is the same as that in the second embodiment. Specifically, the configuration has a wireless communication function using the UWB method in addition to the configuration of the information processing device 1 of the first embodiment.

In the third embodiment, instead of the communication device 2, a communication device 2A is used as a tag. Although not illustrated, the communication device 2A serving as a tag is configured to be able to perform communication processing for distance measurement using the phase-based method like the communication device 2, and has a wireless communication function using the UWB method.

As illustrated in FIG. 22, the CPU 11 in this case has the functions as a selection processing unit F5, a determination processing unit F2B, and a distance measurement control unit F6.

The selection processing unit F5 performs processing of selecting a communication device 2A from a plurality of communication devices 2A.

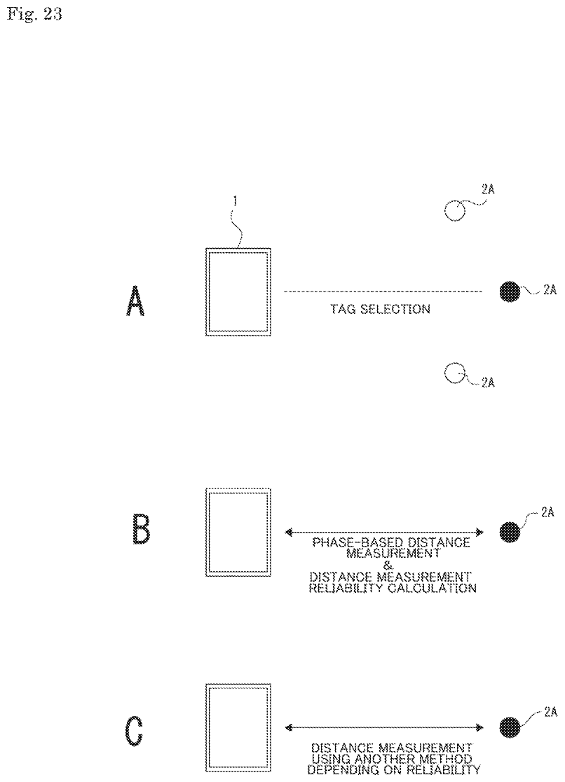

FIG. 23 illustrates explanatory diagrams of a flow of distance measurement in the third embodiment.

As illustrated, in this example, tag search is performed for a tag selected from a plurality of tags.

The selection processing unit F5 performs processing of selecting one communication device 2A from among the plurality of communication devices 2A serving as tags in response to a user's selection operation (see A of FIG. 23).

In FIG. 22, the determination processing unit F2B determines whether or not to perform distance measurement using a method other than the phase-based method, based on information on a distance measurement reliability.

In the tag search of this example, the CPU 11 executes distance measurement using the phase-based method for the selected communication device 2A, and calculates a distance measurement reliability based on the frequency characteristics of the phase θ obtained by the distance measurement (see B of FIG. 23).

The determination processing unit F2B determines whether or not to perform distance measurement using a method other than the phase-based method based on the distance measurement reliability thus obtained. Specifically, the determination processing unit F2B obtains a result of determination indicating that distance measurement using a method other than the phase-based method is to be performed unless the distance measurement reliability is equal to or higher than a predetermined value. On the other hand, if the distance measurement reliability is equal to or higher than the predetermined value, the determination processing unit F2B obtains a result of determination indicating that distance measurement using a method other than the phase-based method is not to be performed.

The distance measurement control unit F6 controls the distance measurement using another method based on the result of determination made by the determination processing unit F2B. Specifically, the distance measurement control unit F6 controls the distance measurement using the UWB method in response to the determination made by the determination processing unit F2B to perform distance measurement using another method (see C of FIG. 23).

If the distance measurement reliability is equal to or higher than the predetermined value and the determination processing unit F2B determines that distance measurement using another method is not performed, the CPU 11 performs processing of outputting the result of distance measurement obtained by the distance measurement performed using the phase-based method.

With the distance measurement method as the third embodiment as described above, it is possible to reduce the chances of performing distance measurement using the UWB method in the tag search function, and to reduce power consumption.

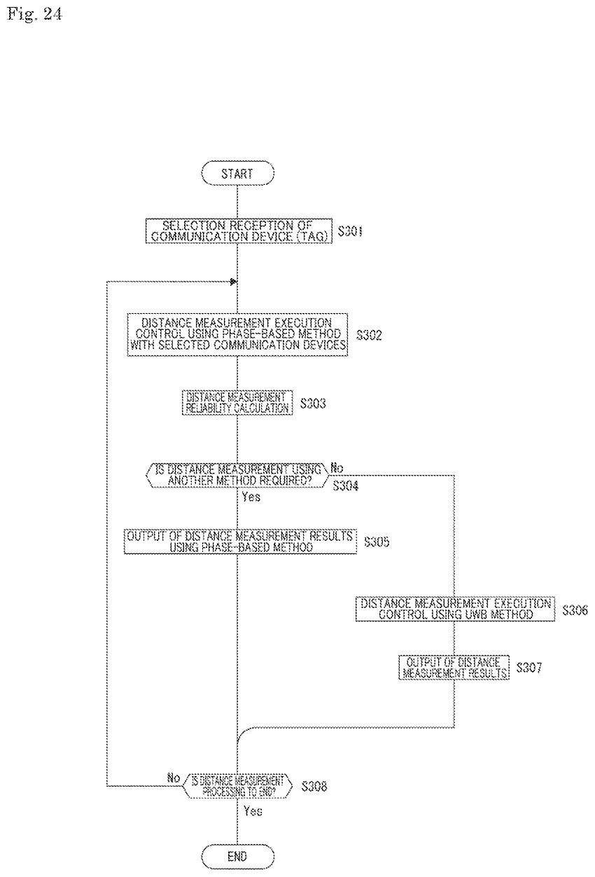

FIG. 24 is a flowchart illustrating an example of a specific processing procedure to implement the distance measurement method as the third embodiment described above.

As illustrated, in step S301, the CPU 11 in this case receives a selection of a communication device 2A (tag), and selects one communication device 2A from the plurality of communication devices 2A in response to the user's selection operation.

In step S302 following step S301, the CPU 11 performs distance measurement execution control using the phase-based method with the selected communication devices 2A.

Furthermore, the CPU 11 executes distance measurement reliability calculation processing in subsequent step S303, and determines in step S304 whether or not distance measurement using another method is required. Specifically, in this example, it is determined whether or not the distance measurement reliability is equal to or higher than a predetermined value, and if the distance measurement reliability is not equal to or higher than the predetermined value, a result of determination is obtained indicating that distance measurement using another method is to be performed (distance measurement using another method is required); if the distance measurement reliability is equal to or higher than the predetermined value, a result of determination is obtained indicating that distance measurement using another method is not to be performed (distance measurement using another method is not required).

If it is determined in step S304 that distance measurement using another method is not required, the CPU 11 proceeds to step S305 to perform processing of outputting the result of distance measurement using the phase-based method, and the processing proceeds to step S308.

On the other hand, if it is determined in step S304 that distance measurement using another method is not required, the CPU 11 proceeds to step S306 to perform distance measurement execution control using the UWB method, performs processing of outputting the result of distance measurement in subsequent step S307, and the processing proceeds to step S308.

In step S308, the CPU 11 determines whether or not the distance measurement processing is to end, and if the distance measurement process is not to end, the processing returns to step S302.

On the other hand, if the distance measurement processing is to end, the CPU 11 ends the series of processing illustrated in FIG. 24.

The distance measurement using another method referred to in the third embodiment is not limited to distance measurement using the UWB method. For example, any distance measurement method through wireless communication that uses at least a wider frequency band than in BLE may be used.

Alternatively, for the distance measurement using another method, for example, distance measurement using a time-of-flight (ToF) method or a light detection and ranging (LiDAR) method may be used.

### 4. Modification Example

Embodiments are not limited to the specific examples described above, and configurations serving as a variety of variations can be employed as well. For example, configurations have been described above by way of examples in which a terminal device such as a smartphone that performs communication processing for distance measurement using the phase-based method with a communication device 2 performs even position measurement. However, in place of that, a configuration may be provided in which the terminal device performs processing for distance measurement, and a cloud server that is capable of network communication with the terminal device performs position measurement calculation using a result of distance measurement obtained from the terminal device and position coordinate information of the communication device 2.

In this case, it is conceivable that the primary selection processing, the determination processing of the determination processing unit F2, and the reselection processing are performed by the cloud server. In other words, this cloud server is configured to execute processing as the information processing device according to the present technology.

In this case, the terminal device may transmit phase θ data (or time-domain waveform data) for each frequency to the cloud server in order to calculate a distance measurement reliability, or the terminal device may calculate a distance measurement reliability and transmit the calculated distance measurement reliability to the cloud server.

There are various ways how the terminal device and the cloud server are allocated for the primary selection processing, the determination processing of the determination processing unit F2, and the reselection processing.

### 5. Summary of Embodiments

As described above, an information processing device (1) as an embodiment includes a determination processing unit (F2, F2A, F2B) that determines, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

By performing the distance measurement using the phase-based method, the reliability information can be obtained indicating the reliability of the distance measurement or the reliability of position measurement based on the results of distance measurement. With the above configuration, for a communication device with a low reliability, a communication device to be used for position measurement can be reselected, and for distance measurement with a low reliability using the phase-based method, distance measurement can be performed using another method.

Therefore, it is possible to improve the accuracy of position measurement based on a result of distance measurement using the phase-based method or distance measurement using a communication device.

Further, the information processing device as the embodiment includes a primary selection processing unit (F1) that primarily selects a plurality of communication devices to be used for position measurement, and the determination processing unit (F2) determines, based on the reliability information obtained for the communication devices primarily selected by the primary selection processing unit, whether or not reselection of a communication device to be used for position measurement is required.

This makes it possible to reselect a communication device to be used for position measurement when there is a communication device with a low reliability among the primarily selected communication devices.

Therefore, it is possible to improve the accuracy of position measurement based on the result of distance measurement using the phase-based method.

Further, in the information processing device as the embodiment, the primary selection processing unit performs primary selection based on received signal strength indicators from the communication devices.

Making a selection based on the received signal strength indicators as the primary selection makes it possible to eliminate the need to perform communication processing for distance measurement using the phase-based method with all communication devices that can communicate in position measurement.

Therefore, it is possible to shorten the time required for position measurement and reduce the processing load.

In addition, making a selection based on received signal strength indicators as the primary selection makes it possible to select a communication device that can be expected to improve the accuracy of position measurement and distance measurement in terms of the received signal strength indicators, and thus to avoid reselection as much as possible. Therefore, in this respect as well, it is possible to shorten the time required for position measurement and reduce the processing load.

Furthermore, in the information processing device as the embodiment, the primary selection processing unit performs the primary selection based on position coordinate information indicating positions at which the communication devices are arranged.

Making a selection based on the position coordinate information of the communication devices as the primary selection makes it possible to eliminate the need to perform communication processing for distance measurement using the phase-based method with all communication devices that can communicate in position measurement.

Therefore, it is possible to shorten the time required for position measurement and reduce the processing load.

In addition, making a selection based on the position coordinate information of the communication devices as the primary selection makes it possible to select a communication device that satisfies an arrangement condition for the communication device to be used for position measurement that can be expected to improve the accuracy of position measurement and distance measurement, and thus to avoid reselection as much as possible. Therefore, in this respect as well, it is possible to shorten the time required for position measurement and reduce the processing load.

Further, in the information processing device as the embodiment, the primary selection processing unit performs the primary selection based on received signal strength indicators from the communication devices and position coordinate information indicating positions at which the communication devices are arranged.

Making a selection based on the received signal strength indicators and the position coordinate information of the communication devices as the primary selection makes it possible to eliminate the need to perform communication processing for distance measurement using the phase-based method with all communication devices that can communicate in position measurement. Therefore, it is possible to shorten the time required for position measurement and reduce the processing load.

In addition, making a selection based on the received signal strength indicators and the position coordinate information of the communication devices as the primary selection makes it possible to select a communication device that can be expected to improve the accuracy of position measurement and distance measurement in terms of not only the received signal strength indicators but also the arrangement condition of the communication devices, and thus to avoid reselection as much as possible. Therefore, in this respect as well, it is possible to shorten the time required for position measurement and reduce the processing load.

Furthermore, in the information processing device as the embodiment, the primary selection processing unit performs the primary selection based on: position coordinate information of a device to be subjected to position measurement calculated based on received signal strength indicators from the communication devices; and position coordinate information indicating positions at which the communication devices are arranged.

Even with the above configuration, the primary selection is performed based on the received signal strength indicators and the position coordinate information of the communication devices.

Therefore, it is possible to eliminate the need to perform communication processing for distance measurement using the phase-based method with all communication devices that can communicate in position measurement, and thus to shorten the time required for position measurement and reduce the processing load.

In addition, the primary selection is performed based on the position coordinate information of the device to be subjected to position measurement calculated from the received signal strength indicators and the position coordinate information of the communication devices as described above, so that it is possible to select a communication device that can be expected to improve the accuracy of position measurement and distance measurement based on the relationship between the rough position of the device to be subjected to position measurement and the positions of the communication devices, and thus to avoid reselection as much as possible. Therefore, in this respect as well, it is possible to shorten the time required for position measurement and reduce the processing load.

Furthermore, in the information processing device as the embodiment, the determination processing unit determines whether or not reselection is required, based on distance measurement reliability information that is reliability information on distance measurement.

The position measurement in this case is performed based on the result of distance measurement obtained using the phase-based method. Therefore, using the distance measurement reliability information that indicates the reliability of distance measurement using the phase-based method makes it possible to accurately make a reselection determination, that is, a determination as to whether or not a communication device is to be reselected for position measurement.

Further, in the information processing device as the embodiment, the determination processing unit determines whether or not reselection is required, based on position measurement reliability information that is reliability information on position measurement.

The distance measurement reliability information may be calculated to be a value different from the true value due to some factor.

As mentioned above, making a determination to reselect a communication device based on the reliability information on position measurement instead of distance measurement makes it possible to accurately make a reselection determination even when the distance measurement reliability information may be inaccurate.

Furthermore, the information processing device as the embodiment includes a reselection processing unit (F3) that reselects a communication device to be used for position measurement when the determination processing unit determines that reselection is required.

This makes it possible to reselect a communication device to be used for position measurement when there is a communication device with a low reliability among the primarily selected communication devices.

Therefore, it is possible to improve the accuracy of position measurement based on the distance measurement result using the phase-based method.

Furthermore, in the information processing device as the embodiment, the reselection processing unit performs the reselection based on reliability information on distance measurement obtained for each of the primarily selected communication devices.

As a result, a communication device with a high reliability for distance measurement among the primarily selected communication devices is excluded from devices to be reselected, and only the remaining number of communication devices required for position measurement can be reselected.

Therefore, it is possible to improve the efficiency of processing related to reselection.

Further, in the information processing device as the embodiment, the reselection processing unit performs the reselection based on received signal strength indicators from the communication devices.

This makes it possible to eliminate the need to perform distance measurement using the phase-based method with all communication devices to be reselected in reselection.

Therefore, it is possible to shorten the time required for position measurement and reduce the processing load.

In addition, making a selection based on the received signal strength indicators as the reselection makes it possible to reselect a communication device that can be expected to improve the accuracy of position measurement and distance measurement in terms of the received signal strength indicators, and thus to avoid further selecting a communication device after reselection as much as possible. Therefore, in this respect as well, it is possible to shorten the time required for position measurement and reduce the processing load.

Furthermore, in the information processing device as the embodiment, the reselection processing unit performs the reselection based on position coordinate information indicating positions at which the communication devices are arranged.

This makes it possible to eliminate the need to perform communication processing for distance measurement using the phase-based method with all communication devices to be reselected in reselection.

Therefore, it is possible to shorten the time required for position measurement and reduce the processing load.

In addition, making a selection based on the position coordinate information of the communication devices as the reselection makes it possible to select a communication device that satisfies an arrangement condition for the communication device to be used for position measurement that can be expected to improve the accuracy of position measurement and distance measurement, and thus to avoid further selecting a communication device after reselection as much as possible. Therefore, in this respect as well, it is possible to shorten the time required for position measurement and reduce the processing load.

Furthermore, in the information processing device as the embodiment, the reselection processing unit performs the reselection based on: position coordinate information of a device to be subjected to position measurement obtained by position measurement based on a result of distance measurement using the phase-based method performed for each of the primarily selected communication devices; and position coordinate information indicating a position at which the communication device is arranged.

This makes it possible to eliminate the need to perform communication processing for distance measurement using the phase-based method with all communication devices to be reselected in reselection.

Therefore, it is possible to shorten the time required for position measurement and reduce the processing load.

In addition, making a selection based on the position coordinate information of the device to be subjected to position measurement obtained from the phase-based distance measurement result for the primary selection and the position coordinate information of the communication devices as the reselection makes it possible to select a communication device that satisfies an arrangement condition for the device to be subjected to position measurement and the communication device to be used for position measurement that can be expected to improve the accuracy of position measurement and distance measurement, and thus to avoid further selecting a communication device after reselection as much as possible. Therefore, in this respect as well, it is possible to shorten the time required for position measurement and reduce the processing load.

Further, in the information processing device as the embodiment, the reselection processing unit performs the reselection so that the number of communication devices that will be in a selected state after reselection matches a prescribed number for position measurement.

The prescribed number for position measurement as used herein means a value that defines the number of communication devices to be used in the position measurement processing to obtain the result of position measurement to be output. Performing reselection of a communication device so that the communication devices match the prescribed number for position measurement as described above makes is possible to minimize the number of communication devices to be subjected to distance measurement using the phase-based method to calculate reliability information when the reselected communication device is determined again based on the reliability information.

Therefore, it is possible to shorten the time required for redetermination after reselection and reduce the processing load related to the redetermination.

Further, in the information processing device as the embodiment, the reselection processing unit performs the reselection so that the number of communication devices that will be in a selected state after reselection is greater than a prescribed number for position measurement.

If reselection is performed so that the number of communication devices that will be in the selected state after reselection is equal to the prescribed number for position measurement, for a reselected communication device with a low reliability, it is necessary to select another communication device immediately. On the other hand, if reselection is performed so that the number of communication devices that will be in the selected state after reselection is greater than the prescribed number for position measurement as described, even when one reselected communication device has a low reliability, there is a possibility that another reselected communication device has a high reliability. Thus, even when one reselected communication device has a low reliability, it is possible to eliminate the need to immediately select another communication device.

Therefore, it is possible to shorten the time required for position measurement and reduce the processing load related to position measurement.

Furthermore, in the information processing device as the embodiment, the determination processing unit (F2A, F2B) determines whether or not to perform distance measurement using a method other than the phase-based method, based on reliability information on distance measurement.

As a result, when distance measurement using the phase-based method has a low reliability, it is possible to determine that distance measurement is to be performed using another method that can be expected to have a higher distance measurement accuracy, such as the UWB method.

Therefore, it is possible to improve distance measurement accuracy.

Furthermore, the information processing device as the embodiment includes a distance measurement control unit (F4, F6) that controls distance measurement using another method based on a result of determination made by the determination processing unit.

As a result, when distance measurement using the phase-based method has a low reliability, it is possible to switch the distance measurement to distance measurement using another method that can be expected to have a higher distance measurement accuracy, such as the UWB method.

Therefore, it is possible to improve distance measurement accuracy.

Furthermore, in the information processing device as the embodiment, the distance measurement using the phase-based method is performed through wireless communication using BLE, and the distance measurement control unit controls the distance measurement through wireless communication that uses a wider frequency band than BLE, as distance measurement using another method.

As a result, in a case where distance measurement using the phase-based method has a low reliability, the distance measurement can be switched to distance measurement through wireless communication with a wider frequency band, that is, distance measurement using a method that is expected to further improve distance measurement accuracy.

Therefore, it is possible to improve distance measurement accuracy.

Further, an information processing method as an embodiment includes, by an information processing device, determining, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

With such an information processing method as well, the same operations and effects as those of the information processing device as the embodiment described above can be obtained.

Here, as an embodiment, a program may be provided that causes, for example, a CPU, a digital signal processor (DSP), or the like, or a device including these, to execute the processing performed by the determination processing units F2, F2A, F2B described with reference to FIGS. 15 to 19, FIG. 21, and FIG. 24.

Specifically, the program according to the embodiment is a program that is readable by a computer device, and is also a program that causes the computer device to implement a function of determining, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

With such a program, the functions of the determination processing units F2, F2A, and F2B described above can be implemented in a device such as the information processing device 1.

The program as described above can be recorded in advance in an HDD serving as a recording medium built in a device such as a computer device or a ROM or the like in a microcomputer that includes a CPU.

Alternatively, the program can be stored (recorded) temporarily or perpetually on a removable recording medium such as a flexible disc, a compact disc read-only memory (CD-ROM), a magneto optical (MO) disc, a digital versatile disc (DVD), a Blu-ray Disc (registered trademark), a magnetic disk, a semiconductor memory, or a memory card. The removable recording medium can be provided as what is known as package software.

The program can be installed from the removable recording medium on a personal computer or the like and can also be downloaded from a download site via a network such as a local area network (LAN) or the Internet.

Such a program is suitable for widely providing the determination processing units F2, F2A, and F2B of the embodiments. For example, the program is downloaded to a personal computer, a portable information processing device, a mobile phone, a game console, a video device, a personal digital assistant (PDA), or the like, making it possible for the personal computer or the like to function as a device that implements the processing of the determination processing units F2, F2A, and F2B according to the present disclosure.

Note that the advantageous effects described in the present specification are merely exemplary and are not limited, and other advantageous effects may be obtained.

### 6. Present Technology

The present technology can be configured as follows.

(1)

An information processing device including a determination processing unit that determines, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

(2)

The information processing device according to (1), including a primary selection processing unit that primarily selects a plurality of the communication devices to be used for position measurement,
wherein the determination processing unit
determines, based on the reliability information obtained for the communication devices primarily selected by the primary selection processing unit, whether or not reselection of the communication devices to be used for position measurement is required.
   (3)

The information processing device according to (2), wherein the primary selection processing unit
performs the primary selection based on received signal strength indicators from the communication devices.
   (4)

The information processing device according to (2), wherein
the primary selection processing unit
performs the primary selection based on position coordinate information indicating positions at which the communication devices are arranged.
   (5)

The information processing device according to (2), wherein
the primary selection processing unit
performs the primary selection based on received signal strength indicators from the communication devices and position coordinate information indicating positions at which the communication devices are arranged.
   (6)

The information processing device according to (5), wherein
the primary selection processing unit
performs the primary selection based on: position coordinate information of a device to be subjected to position measurement calculated based on received signal strength indicators from the communication devices; and position coordinate information indicating positions at which the communication devices are arranged.
   (7)

The information processing device according to any one of (2) to (6), wherein the determination processing unit
determines whether or not reselection is required, based on distance measurement reliability information that is the reliability information on distance measurement.
   (8)

The information processing device according to any one of (2) to (7), wherein the determination processing unit determines whether or not the reselection is required, based on position measurement reliability information that is the reliability information on position measurement.

(9)

The information processing device according to any one of (2) to (8), including a reselection processing unit that reselects the communication device to be used for position measurement when the determination processing unit determines that the reselection is required.

(10)

The information processing device according to (9), wherein the reselection processing unit
performs the reselection based on the reliability information on distance measurement obtained for each of the primarily selected communication devices.
   (11)

The information processing device according to (9) or (10), wherein the reselection processing unit
performs the reselection based on received signal strength indicators from the communication devices.
   (12)

The information processing device according to (9) or (10), wherein the reselection processing unit
performs the reselection based on position coordinate information indicating positions at which the communication devices are arranged.
   (13)

The information processing device according to (9) or (10), wherein the reselection processing unit
performs the reselection based on: position coordinate information of a device to be subjected to position measurement obtained by position measurement based on a result of distance measurement using the phase-based method performed for each of the primarily selected communication devices; and position coordinate information indicating positions at which the communication devices are arranged.
   (14)

The information processing device according to any one of (9) to (13), wherein the reselection processing unit
performs the reselection so that the number of the communication devices that will be in a selected state after reselection matches a prescribed number for position measurement.
   (15)

The information processing device according to any one of (9) to (13), wherein the reselection processing unit
performs the reselection so that the number of the communication devices that will be in a selected state after reselection is greater than a prescribed number for position measurement.
   (16)

The information processing device according to (1), wherein the determination processing unit
determines whether or not to perform distance measurement using a method other than the phase-based method, based on the reliability information on distance measurement.
   (17)

The information processing device according to (16), including a distance measurement control unit that controls distance measurement using the other method based on a result of determination made by the determination processing unit.

(18)

The information processing device according to (17), wherein
the distance measurement using the phase-based method is performed through wireless communication using BLE, and
the distance measurement control unit
controls distance measurement through wireless communication that uses a wider frequency band than BLE, as the distance measurement using the other method.
   (19)

An information processing method including, by an information processing device,
determining, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.
   (20)

A program readable by a computer device,
the program causing the computer device to implement a function of determining, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

### REFERENCE SIGNS LIST

1 Information processing device
2, 2A Communication device
11 CPU
12 ROM
13 RAM
14 Nonvolatile memory unit
15 Input/output interface
16 Input unit
17 Display unit
18 Sound output unit
19 Storage unit
20 Communication unit
21 Drive
22 Removable recording medium
23 Bus
30 Wireless communication module
31 Computation unit
31a Frequency-phase characteristic acquisition unit
31b Distance calculation unit
32 Modulator
33 DAC
34 Transmission unit
35 BPF
36 Mixer
37 Frequency synthesizer
38 RF switch
39 Antenna
40 Reception unit
41 LNA
42 Mixer
43,45 BPF
44,46 VGA
47 ADC
X Obstacle
F1 Primary selection processing unit
FlA Selection processing unit
F2, F2A, F2B Determination processing unit
F3 Reselection processing unit
F4 Distance measurement control unit
F5 Selection processing unit
F6 Distance measurement control unit

1. An information processing device comprising a determination processing unit that determines, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

2. The information processing device according to claim 1, including a primary selection processing unit that primarily selects a plurality of the communication devices to be used for position measurement,
wherein the determination processing unit
determines, based on the reliability information obtained for the communication devices primarily selected by the primary selection processing unit, whether or not reselection of the communication devices to be used for position measurement is required.

3. The information processing device according to claim 2, wherein the primary selection processing unit
performs the primary selection based on received signal strength indicators from the communication devices.

4. The information processing device according to claim 2, wherein the primary selection processing unit
performs the primary selection based on position coordinate information indicating positions at which the communication devices are arranged.

5. The information processing device according to claim 2, wherein the primary selection processing unit
performs the primary selection based on received signal strength indicators from the communication devices and position coordinate information indicating positions at which the communication devices are arranged.

6. The information processing device according to claim 5, wherein the primary selection processing unit
performs the primary selection based on: position coordinate information of a device to be subjected to position measurement calculated based on received signal strength indicators from the communication devices; and position coordinate information indicating positions at which the communication devices are arranged.

7. The information processing device according to claim 2, wherein the determination processing unit
determines whether or not the reselection is required, based on distance measurement reliability information that is the reliability information on distance measurement.

8. The information processing device according to claim 2, wherein the determination processing unit
determines whether or not the reselection is required, based on position measurement reliability information that is the reliability information on position measurement.

9. The information processing device according to claim 2, comprising a reselection processing unit that reselects the communication device to be used for position measurement when the determination processing unit determines that the reselection is required.

10. The information processing device according to claim 9, wherein the reselection processing unit performs the reselection based on the reliability information on distance measurement obtained for each of the primarily selected communication devices.

11. The information processing device according to claim 9, wherein the reselection processing unit performs the reselection based on received signal strength indicators from the communication devices.

12. The information processing device according to claim 9, wherein the reselection processing unit performs the reselection based on position coordinate information indicating positions at which the communication devices are arranged.

13. The information processing device according to claim 9, wherein the reselection processing unit
performs the reselection based on: position coordinate information of a device to be subjected to position measurement obtained by position measurement based on a result of distance measurement using the phase-based method performed for each of the primarily selected communication devices; and position coordinate information indicating positions at which the communication devices are arranged.

14. The information processing device according to claim 9, wherein the reselection processing unit
performs the reselection so that the number of the communication devices that will be in a selected state after reselection matches a prescribed number for position measurement.

15. The information processing device according to claim 9, wherein the reselection processing unit
performs the reselection so that the number of the communication devices that will be in a selected state after reselection is greater than a prescribed number for position measurement.

16. The information processing device according to claim 1, wherein the determination processing unit
determines whether or not to perform distance measurement using a method other than the phase-based method, based on the reliability information on distance measurement.

17. The information processing device according to claim 16, including a distance measurement control unit that controls distance measurement using the other method based on a result of determination made by the determination processing unit.

18. The information processing device according to claim 17, wherein
the distance measurement using the phase-based method is performed through wireless communication using BLE, and
the distance measurement control unit
controls distance measurement through wireless communication that uses a wider frequency band than BLE, as the distance measurement using the other method.

19. An information processing method including, by an information processing device,
determining, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.

20. A program readable by a computer device,
the program causing the computer device to implement a function of determining, based on reliability information on distance measurement or position measurement obtained by performing communication processing for distance measurement using a phase-based method with a selected communication device, whether or not reselection of a communication device to be used for position measurement is required or whether or not to perform distance measurement using a method other than the phase-based method.
